(19) United States
(12) Patent Application Publication
(10) Pub. No.: US 2010/0222898 A1
(43) Pub. Date: Sep. 2, 2010

(54) Stage-control systems and methods including inverse closed loop with adaptive controller

(75) Inventor: Pai-Hsueh Yang, Palo Alto, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/657,806

(22) Filed: Jan. 27, 2010

Related U.S. Application Data
(60) Provisional application No. 61/147,716, filed on Jan. 27, 2009.

(51) Int. Cl. G05D 3/12; G05B 13/04

(52) U.S. Cl. 700/29; 700/60

(57) ABSTRACT

Stage assemblies and control methods are disclosed. An exemplary stage assembly includes a movable stage and a control system. The stage-control system has first and second control loops. In the first control loop a first controller is programmed with a feedback-control transfer-function that determines a feedback-control output from an input including a following-error of the stage. The second control loop includes an inverse closed loop having an inverse plant model and a second controller programmed with an adaptive transfer-function connected to receive inputs including the following-error and the feedback-control output. The second controller determines, from the inputs, an adapted control output to the stage. The adaptive transfer-function can be, e.g., an AFC transfer-function producing an AFC controlled output or an ILC transfer-function producing an ILC controlled output.

### CROSS-REFERENCE TO RELATED APPLICATIONS

This application claims priority to and the benefit of U.S. Provisional Patent Application No. 61/147,716, filed on Jan. 27, 2009, which is incorporated herein by reference in its entirety.

### FIELD

This disclosure pertains to, inter alia, control systems having particular utility in governing the motions and positions achieved by positioning devices such as, but not limited to, stages for holding and moving reticles and substrates in microlithographic systems.

### Background

Many industrial processes require that workpieces, process tools, measurement tools, and the like be accurately positioned and moved, usually while embodying a high degree of automation. In certain processes, such as microlithography widely used in the semiconductor-device and micro-electronics industries, the need to achieve extraordinarily accurate positioning and movements is critical, and modern microlithography systems are achieving position and motion accuracies of their stages in the nanometer range.

The movable portion of a stage inherently has mass, usually substantial mass. Regardless of applicable tolerances, controlling positions and motions of a movable stage having mass involves dealing not only with disturbances originating outside the stage but also with disturbances originating in motions (including accelerations and decelerations) of the stage mass itself. No control system is perfect; each has limitations such as a certain degree of following-error, for example. Also, in microlithography systems comprising multiple stages (e.g., a reticle stage and a substrate stage) errors may exist in the synchrony of relative stage motions. The goal of control systems used with these stages is to achieve a level of stage position and motion control sufficient to meet extremely demanding specifications. As specifications progressively tighten, the need for more accurate and precise control follows apace.

Controlling the effects of vibrations can be especially challenging. With stages, vibrations generally are of three types, namely stage vibrations, vibration of sensors used for sensing stage position, and vibrations of the position reference for stage-position control. Stage vibrations can be of an individual stage or of a relative nature involving two or more stages (e.g., reticle stage and wafer stage configured to move synchronously).

Certain errors may have a periodical nature, i.e., have particular frequencies, that should be reduced to realize more accurate control of position and motion. For example, a stage may exhibit periodical following-errors of a vibrational nature caused by disturbances and variations in target position.

As the accuracy and precision with which high-precision systems must operate have become more stringent, the need for increasingly stringent control of stages and the like has proceeded apace.

### SUMMARY

Methods and apparatus are disclosed herein that address the needs summarized above. According to one aspect, stage assemblies are disclosed. A “stage assembly” is a combination of a movable stage and a control system coupled to and configured to control positioning of the stage. Hence, the control system controls motion of the stage in at least one degree of freedom. A “stage” is not limited to a reticle stage or substrate stage as used in microlithography systems; a “stage” is generally any of various devices that hold and position an object. The object can be a reticle or a substrate, or alternatively a workpiece, a tool, an implement, or the like. The stage is usually operable to position the object relative to another thing such as, but not limited to, a measurement device, an optical system, a tool, a frame, an axis, or the like. The stage may, but not necessarily, include an object holder such as a chuck, clamp, mounting surface, jig, or the like, depending upon application. The stage may be configured to operate at atmospheric pressure, in a pressurized environment, or in a vacuum environment.

An embodiment of a stage assembly comprises a movable stage and a stage-control system coupled to the stage. The stage-control system comprises a first control loop and a second control loop. The first control loop comprises a first controller (or first portion of a controller) programmed with a feedback-control transfer-function that determines a feedback-control output from an input including a following-error of the stage. The second control loop comprises an inverse closed loop that includes an inverse plant model. The second control loop also includes a second controller (or second portion of a controller) programmed with an adaptive transfer-function. The inverse plant model is connected to receive at least one input including the following-error. The second controller is connected to receive at least one input including an output of the inverse closed loop, and is programmed with an adaptive transfer-function that determines, from its at least one input, an adapted control output to the stage. Desirably, the first and second control loops cooperatively reduce at least a periodic component of the following-error.

The inverse plant model desirably is connected to receive an input including the following-error. In such a configuration the inverse plant model produces an output that is summed with a delayed feedback-control output, and the sum is input to the adaptive transfer-function. The inverse plant model desirably is an inverse nominal plant.

The feedback-control output, as input to the second controller, can be delayed to synchronize the feedback-control output with the following-error as input to the second controller.

The second control loop can further comprise phase-ahead to accommodate at least some relative phase lag in the feedback-control output and following-error.

The stage-control system can further include a third control loop configured as an open loop comprising a feed-forward controller. The feed-forward controller has one or more inputs, including but not limited to snap, jerk, position trajectory, velocity trajectory, or position trajectory (or a combination of these) of the stage. In this configuration the output of the feed-forward controller desirably is summed with the output of the second controller.

In one group of embodiments the adaptive transfer-function comprises an AFC transfer-function (adaptive feed-forward canceller) that produces an AFC controlled output. In these embodiments the second controller can include at least one shaping filter, such as a notch-filter or inverse notch-filter. The notch-filter is programmed to attenuate a respective frequency component of the following-error. Multiple notch-filters can be employed, arranged in series or parallel. If multiple notch-filters are employed, their respective outputs are summed to produce the AFC controlled output.

The inverse plant model desirably receives an input including the following-error, and produces an output that is summed with a delayed feedback-control output, the sum being input to the AFC transfer-function. In these embodiments the feedback-control output as input to the second controller is delayed.

In another group of embodiments the adaptive transfer-function comprises an ILC transfer-function (iterative learning control) that produces an ILC controlled output. In these embodiments the second controller can include one or more of an FIR low-pass filter, an ILC buffer, and a time-ahead. If the inverse plant model receives an input including the following-error, the inverse plant model produces an output that is summed with a delayed feedback-control output, wherein the sum is input to the ILC algorithm. The output of the ILC transfer-function is summed with the feedback-control output for delivery to the stage. The summed outputs can be input directly to the stage, or the stage can include, for example, at least one shaping filter that receives the summed outputs. Again, the feedback-control output as input to the second controller can be delayed.

In these embodiments, the stage-control system can include a third control loop configured as an open loop comprising a feed-forward controller with one or more inputs as summarized above. The output of the feed-forward controller desirably is summed with the output of second controller.

According to another aspect of the disclosure, methods are provided for controlling motion and positioning of a stage of a precision system. An embodiment of such a method comprises selecting a trajectory for the stage, producing stage-position data, and determining a stage following-error from the trajectory and from the stage-position data. The following-error is input to a feedback transfer-function to produce a feedback-control output. The following-error is processed in an inverse closed loop, including an inverse plant model, to produce an inverse closed-loop output. The inverse closed-loop output is input to an adaptive transfer-function to produce an adapted control output. The stage is positioned according to the feedback-control output cooperating with the adapted control output.

Positioning of the stage according to the feedback-control output cooperating with the adapted control output can include summing the feedback-control output and adapted control output, and delivering the summed outputs to the stage.

The method can include producing a feed-forward output, and summing the feed-forward output with the summed outputs, wherein positioning the stage includes positioning the stage according to the summed feed-forward output, feedback-control output, and adapted control output. The feed-forward output desirably is produced by a feed-forward algorithm having one or more inputs such as, but not limited to, snap, jerk, position trajectory, velocity trajectory, and acceleration trajectory.

The feedback-control output as input to the adaptive transfer-function can be delayed, such as by a discrete time or a continuous time.

The adaptive transfer-function can comprise an AFC algorithm from which the adapted control output is an AFC controlled output. In these embodiments processing according to the AFC algorithm can include processing according to at least one shaping algorithm and/or notch algorithm.

Alternatively, the adaptive transfer-function can comprise an ILC algorithm, from which the adapted control output is an ILC controlled output. In these embodiments positioning the stage according to the feedback-control output cooperating with the adapted control output includes summing the feedback-control output and the adapted control output, and passing the summed control outputs through a shaping filter before delivery to the stage.

The foregoing and additional features and advantages of the invention will be more readily apparent from the detailed description, which proceeds with reference to the accompanying drawings.

### BRIEF DESCRIPTION OF THE DRAWINGS

FIG. 1 is a schematic depiction of an example precision system, namely a microlithographic exposure apparatus, including a stage and an embodiment of a stage controller as disclosed herein.

FIG. 2(A) is a perspective view of an embodiment of a stage assembly used for moving and positioning an object.

FIG. 2(B) is a perspective view of a stage assembly including a “coarse” stage and a “fine” stage.

FIG. 2(C) is a perspective view of another embodiment of a stage assembly.

FIG. 3(A) is a graph of an actual and intended iterative movement of a stage such as of the fine stage in FIG. 2(A).

FIG. 3(B) shows, with respect to the stage exhibiting the motions in FIG. 3(A), an example following-error during each of multiple iterations.

FIG. 4 is a schematic diagram of an embodiment of a stage-control system.

FIG. 5(A) is a schematic diagram of a stage-control system in which a shaping filter providing adaptive feedback cancellation (AFC) is located upstream of the feedback controller.

FIG. 5(B) is a schematic diagram of a stage-control system in which a shaping filter providing AFC is located downstream of the feedback controller.

FIG. 6(A) is a schematic diagram of a stage-control system in which an inverse notch-filter providing AFC is located upstream of the feedback controller.

FIG. 6(B) is a schematic diagram of a stage-control system in which an inverse notch-filter providing AFC is located downstream of the feedback controller.

FIG. 7 is a schematic diagram of a stage-control system in which AFC is provided by a shaping filter located downstream of the feedback controller and comprising multiple inverse notch-filters arranged in series.

FIG. 8 is a schematic diagram of a stage-control system in which all the target frequencies are located within the closed-loop bandwidth, and the shaping filter comprising multiple inverse notch-filters arranged in series is located downstream of the feedback controller.

FIG. 9 is a schematic diagram of a stage-control system in which AFC is provided by multiple notch-filters arranged in parallel, downstream of the feedback controller.

FIG. 10 is a schematic diagram of a stage-control system including a simplified parallel multiple-frequency AFC.

FIG. 11 is a schematic diagram of a stage-control system from which the configuration shown in FIG. 10 was derived.

FIG. 12 is a schematic diagram of an embodiment of a stage-control system including an inverse closed loop in which AFC is implemented with delayed feedback-force input to synchronize the timing of following-error and feedback-force inputs, wherein AFC is provided by multiple parallel notch-filters.

FIG. 13(A) is a Bode diagram of results obtained in Example 1.

FIG. 13(B) is a frequency spectrum of sensitivity obtained in Example 1.

FIG. 13(C) is a frequency spectrum of disturbance-force rejection obtained in Example 1.

FIG. 14(A) is a Bode diagram of results obtained in Example 2.

FIG. 14(B) is a frequency spectrum of sensitivity obtained in Example 2.

FIG. 14(C) is a frequency spectrum of disturbance-force rejection obtained in Example 2.

FIG. 15(A) is a schematic diagram of a stage-control system in which an ILC controller is utilized, with error input and force output.

FIG. 15(B) is a schematic diagram of a stage-control system in which an ILC controller is utilized, with force input and force output.

FIG. 15(C) is a schematic diagram of a stage-control system in which an ILC controller is utilized, with error input and error output.

FIG. 15(D) is a block diagram for an ILC controller, which is applied to a stage control system in FIG. 15(A), 15(B), or 15(C).

FIG. 16 is a schematic diagram of an embodiment of a control system in which the configurations of FIGS. 15(B) and 15(C) are combined.

FIG. 17(A) is a schematic diagram of an embodiment of a stage-control system, based on the system of FIG. 16, comprising an inverse closed-loop that includes ILC but lacks a low-pass filter on the plant delay receiving feedback-force input.

FIG. 17(B) is a schematic diagram of an embodiment of a stage-control system, similar in respects to FIG. 17(A), but in which the plant delay includes a low-pass filter.

FIG. 18(A) is a simplified schematic diagram of a stage-control system including following-error ILC.

FIG. 18(B) is a simplified schematic diagram of a stage-control system including feedback-force ILC.

FIG. 18(C) is a simplified schematic diagram of an embodiment of a stage-control system that is a combination of the systems of FIGS. 18(A) and 18(B).

FIG. 19(A) is a Bode diagram of results, obtained in Example 3, pertaining to a shaped reticle-stage plant and its inverse-plant model (with 1100-Hz low-pass).

FIG. 19(B) is a Bode diagram of results, obtained in Example 3, pertaining to a reticle-stage closed-loop and its inverse-plant model.

FIG. 20 is a frequency spectrum of iteration-wise residual error ratio in the reticle-stage model.

FIG. 21(A) is a plot of stage trajectory versus time, as obtained in Example 5.

FIG. 21(B) is a plot of planar following-error versus iteration, as obtained in Example 5.

FIG. 21(C) is a plot of vertical following-error versus iteration, as obtained in Example 5.

FIG. 22 is a process flow diagram of steps of an embodiment of a method for fabricating a semiconductor device (as an exemplary microelectronic device).

FIG. 23 is a process flow diagram of steps of an embodiment of a method for processing a wafer, i.e., step 1304 of FIG. 22.

### DETAILED DESCRIPTION

This disclosure is set forth in the context of representative embodiments that are not intended to be limiting in any way.

### Precision System

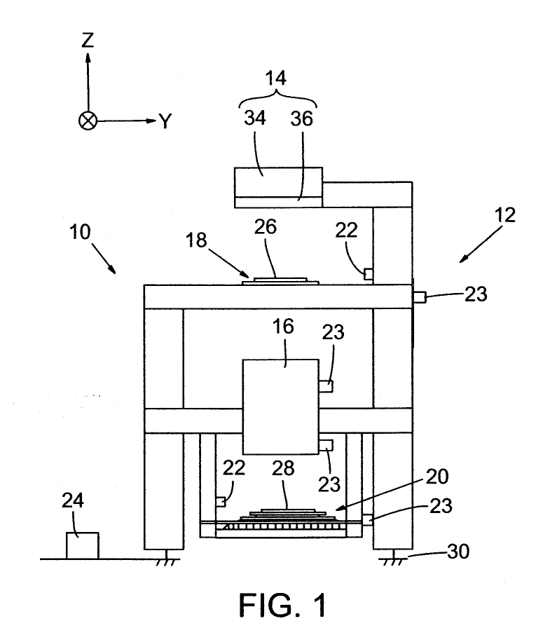

FIG. 1 is a schematic illustration of an exemplary precision system, namely a microlithographic exposure apparatus 10, embodying the current invention. The exposure apparatus 10 includes an apparatus frame 12, an illumination system 14, an assembly 16 (e.g., an optical assembly), a reticle-stage assembly 18, a wafer-stage assembly 20, a measurement system 22, one or more sensors 23, and a control system 24. The respective configurations of the components of the exposure apparatus 10 can be varied to suit the design requirements of the exposure apparatus 10. Details of the exposure apparatus 10 are provided later below.

### Stages

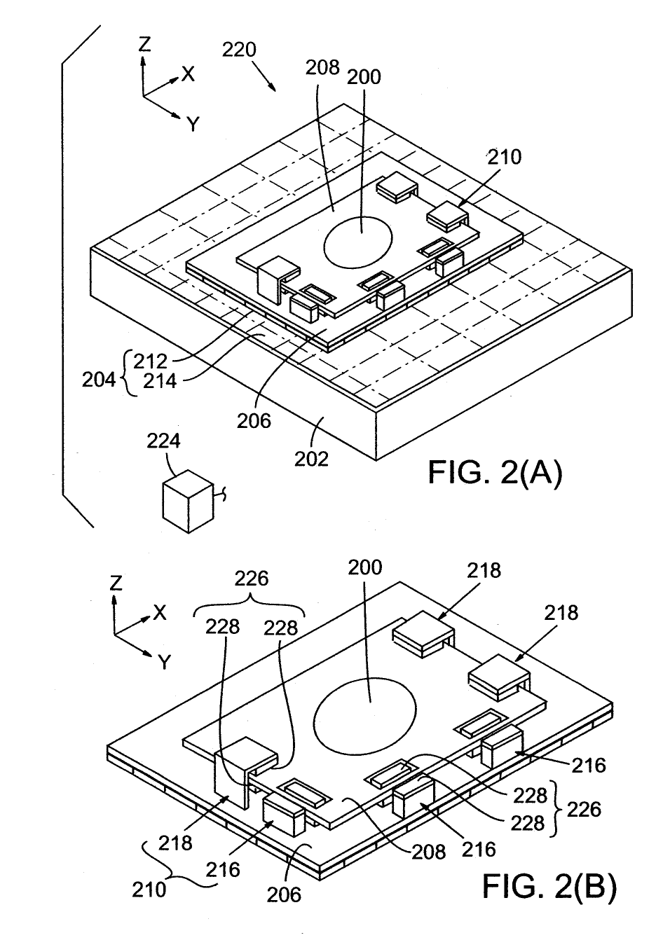

FIG. 2(A) is a perspective view of an exemplary stage assembly 220 used for moving and positioning an object 200, and a control system 224 for the stage assembly. The stage assembly 220 can be used as, for example, the wafer-stage assembly 20 in the exposure apparatus 10 of FIG. 1, wherein the stage assembly 220 moves and positions the wafer 28 during manufacture of micro-devices on the wafer. The control system 224 can be a portion of the stage assembly 220 or can be located elsewhere in the exposure apparatus. Alternatively to being part of an exposure apparatus, the stage assembly 220 can be used for moving and positioning other types of objects 200 during manufacturing and/or inspection, such as moving and positioning an object under an electron microscope (not shown), or for moving and positioning an object during a precision measurement operation (not shown).

Further alternatively, for example, the stage assembly 220 can be used as the reticle-stage assembly 18 in the exposure apparatus 10 of FIG. 1, in which the stage assembly 220 moves and positions the reticle 26 during manufacture of micro-devices on the wafer 28.

The stage assembly 220 includes a stage base 202, a coarse-stage mover assembly 204, a coarse stage 206, a fine stage 208, and a fine-stage mover assembly 210. The configuration of the components of the stage assembly 220 can be varied as required. For example, in FIG. 2(A), the stage assembly 220 includes one coarse stage 206 and one fine stage 208. Alternatively, the stage assembly 220 is configured to include more or less than one coarse stage 206 or more or less than one fine stage 208.

Herein, the terms “coarse stage” 206 and “fine stage” 208 can be used interchangeably with the first stage and the second stage, in either order. It will be understood that this particular stage assembly 220 is exemplary of various types of stage assemblies, and is in no way intended to be limiting. The stage assembly 220 can be constructed according to relevant industry standards that are generally known to those skilled in the art.

The stage base 202 is generally rectangularly shaped. Alternatively, the stage base 202 can be another shape. The stage base 202 supports some of the components of the stage assembly 220 above the mounting base 30 illustrated in FIG. 2(A).

The configuration of the coarse-stage mover assembly 204 can be varied to suit the movement requirements of the stage assembly 220. In one embodiment, the coarse-stage mover assembly 204 includes one or more movers, such as rotary motors, voice-coil motors, linear motors utilizing a Lorentz force to generate a driving force, electromagnetic actuators, planar motors, or other force actuators.

The coarse-stage mover assembly 204 moves the coarse stage 206 relative to the stage base 202 along the X-axis, along the Y-axis, and about the Z-axis (collectively “the planar degrees of freedom” x, y, and θ_{z}, respectively). Additionally, the coarse-stage mover assembly 204 can be configured to move and position the coarse stage 206 along the Z-axis, about the X-axis and/or about the Y-axis relative to the stage base 202 (z, θₓ, and θ_{y}, respectively). Alternatively, for example, the coarse-stage mover assembly 204 can be configured to move the coarse stage 206 with fewer than three degrees of freedom.

In FIG. 2(A) the coarse-stage mover assembly 204 includes a planar motor, wherein a first mover component 212 is secured to and moves with the coarse stage 206 and a second mover component 214 (illustrated in phantom) is secured to the stage base 202. The configuration of each of these components can be varied. For example, one of the mover components 212, 214 can include a magnet array having a plurality of magnets and the other of the mover components 214, 212 can include a conductor array having a plurality of conductors.

In FIG. 2(A) the first mover component 212 includes the magnet array, and the second mover component 214 includes the conductor array. Alternatively, the first mover component 212 can include the conductor array and the second mover component 214 can include the magnet array. The size and shape of the conductor array and the magnet array and the number of conductors in the conductor array and the number of magnets in the magnet array can be varied to suit specific requirements.

The first mover component 212 can be maintained above the second mover component 214 using vacuum pre-load type air bearings (not shown). With this configuration, the coarse stage 206 is movable relative to the stage base 202 with three degrees of freedom (x, y, and θ_{z}). Alternatively, the first mover component 212 could be supported above the second mover component 214 by other ways, such as guides, a rolling-type bearing, or by the magnetic levitation forces. Further alternatively or in addition, the coarse-stage mover assembly 204 can be configured to be movable with up to six degrees of freedom (x, y, z, θₓ, θ_{y}, θ_{z}). Further alternatively, the coarse-stage mover assembly 204 can be configured to include one or more electromagnetic actuators.

The control system 224 directs electrical current to one or more of the conductors in the conductor array. The electrical current through the conductors causes the conductors to interact with the magnetic field of the magnet array. This generates a force between the magnet array and the conductor array that can be used to control, move, and position the first mover component 212 and the coarse stage 206 relative to the second mover component 214 and the stage base 202. The control system 224 adjusts and controls the current level for each conductor to achieve the desired resultant forces. In other words, the control system 224 directs current to the conductor array to position the coarse stage 206 relative to the stage base 202.

The fine stage 208 includes an object holder (not shown) that retains the object 200. The object holder can include a vacuum chuck, an electrostatic chuck, or clamp.

The fine-stage mover assembly 210 moves and adjusts the position of the fine stage 208 relative to the coarse stage 206. For example, the fine-stage mover assembly 210 can adjust the position of the fine stage 208 with six degrees of freedom (x, y, z, θₓ, θ_{y}, θ_{z}). Alternatively, for example, the fine-stage mover assembly 210 can be configured to move the fine stage 208 with only three degrees of freedom. The fine-stage mover assembly 210 can include one or more rotary motors, voice-coil motors, linear motors, electromagnetic actuators, or other type of actuators. Further alternatively, the fine stage 208 can be fixed to the coarse stage 206.

FIG. 2(B) illustrates a perspective view of the coarse stage 206, the fine stage 208, and the fine-stage mover assembly 210 of FIG. 2(A). In this embodiment, the fine-stage mover assembly 210 includes three spaced-apart, horizontal movers 216 and three spaced-apart, vertical movers 218. The horizontal movers 216 move the fine stage 208 along the X-axis, along the Y-axis, and about the Z-axis (x, y, and θ_{z}, respectively) relative to the coarse stage 206, while the vertical movers 218 move the fine stage 208 about the X-axis, about the Y-axis, and along the Z-axis (θₓ, θ_{y}, z, respectively) relative to the coarse stage 206.

In FIG. 2(B) each of the horizontal movers 216 and each of the vertical movers 218 includes a respective actuator pair 226 comprising two electromagnetic actuators 228 (illustrated as blocks in the figure). Alternatively, for example, one or more of the horizontal movers 216 and/or one or more of the vertical movers 218 can include a voice-coil motor or other type of mover.

One of the actuator pairs 226 (one of the horizontal movers 216) is mounted so that the attractive forces produced thereby are substantially parallel with the X-axis.

Two of the actuator pairs 226 (two of the horizontal movers 216) are mounted so that the attractive forces produced thereby are substantially parallel with the Y-axis. Three actuator pairs 226 (the vertical horizontal movers 216) are mounted so that the attractive forces produced thereby are substantially parallel with the Z-axis. With this arrangement: (a) the horizontal movers 216 can make fine adjustments to the position of the fine stage 208 along the X-axis, along the Y-axis, and about the Z-axis (x, y, and θ_{z}, respectively), and (b) the vertical movers 218 can make fine adjustments to the position of the fine stage 208 along the Z-axis, about the X-axis, and about the Y-axis (z, θₓ, θ_{y}, respectively).

Alternatively, for example, two actuator pairs 226 can be mounted parallel to the X-direction, and one actuator pair 226 can be mounted parallel to the Y-direction. Further alternatively, other arrangements of the actuator pairs 226 can be utilized.

In one embodiment, the measurement system 22 (FIG. 1) includes one or more sensors (not shown in FIG. 2(B)) that monitor the position of the fine stage 208 relative to the coarse stage 206 and/or the position of fine stage 208 relative to another structure, such as the assembly 16 (FIG. 1). Data from the measurement system 22 are provided to the control system 224 as provided herein.

FIG. 2(C) is a perspective view of another embodiment of a stage assembly 220D that can be used to position an object 200D, and a control system 224D having features of the present invention. The stage assembly 220D includes a stage base 202D, an X-mover assembly 204D, a Y-mover assembly 206D, a stage 208D that retains the object 200D, and a guide assembly 210D. In this embodiment, the X-mover assembly 204D includes a first X-mover 250D and a second X-mover 252D that move the guide assembly 210D and the stage 208D along the X-axis and about the Z-axis (x and θ_{z}, respectively). The Y-mover assembly 206D includes a Y-mover 254D that moves the stage 208D along the Y-axis. The number of X-movers and Y-movers can vary, and the number of mover assemblies can vary. Also, the design of the other components of the stage assembly 220D can be varied. The stage assembly 220D is described in greater detail in U.S. patent application Ser. No. 09/557,122, filed on Apr. 24, 2000, incorporated herein by reference. The stage assembly 220D can be configured in accordance with industry standards that are generally known to those skilled in the art and/or in accordance with the stage assembly disclosed in the '122 U.S. application cited above.

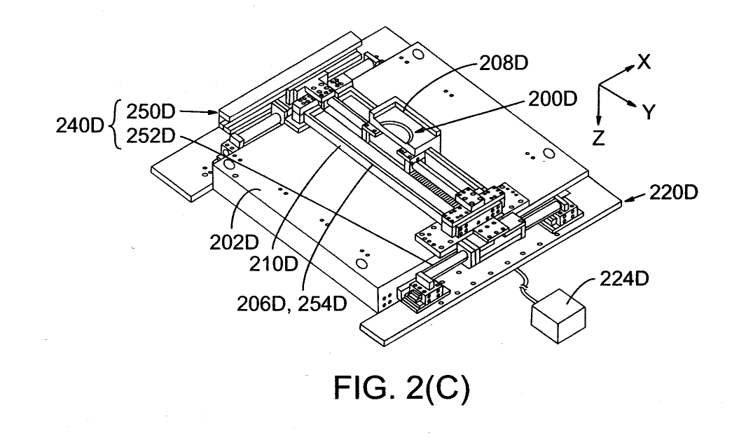

The stage assembly 220D or the stage assembly 220 (FIG. 2(A)) can be used to move the object 200, 200D during one or more iterations. As defined herein, a “first iteration” is said to be identical or similar to a “second iteration” if the first iteration includes a first intended trajectory that is identical or a similar to a second intended trajectory of the second iteration. There are many different examples of first and second intended trajectories of the stage, including trajectories that are identical or similar. Two or more intended trajectories can be considered iterations or iterative movements relative to each other under various circumstances. Example trajectories are discussed in paragraphs [0094]-[0114] and shown in FIGS. 3A-3M of U.S. Patent Publication No. 2004/0128918, incorporated herein by reference.

### Stage-Movement Iterations

FIG. 3(A) is a graph providing an overview of an actual and an intended simplified back-and-forth type of iterative movement of a stage, such as the fine stage 208 shown in FIG. 2(A) or the stage 208D of FIG. 2(B), along a single axis as a function of time over the course of a plurality of substantially similar iterations of the stage. The curve 310 (shown as a solid line) illustrates the actual trajectory of the stage, and the curve 312 (shown as a dashed line) illustrates the intended trajectory of the stage. The spacing between the curves 310, 312 has been exaggerated for illustrative purposes. Each iteration can include the intended trajectory of the stage and the actual trajectory of the stage that emulates the intended trajectory. Two or more intended trajectories can be considered iterations under various circumstances, as discussed in U.S. Provisional Application No. 60/424,506.

For illustrative purposes, FIG. 3(A) includes a first iteration 300, a second iteration 302, a third iteration 304, and a portion of a fourth iteration 306, which is also referred to herein as the “current iteration.” The actual trajectory 310 of an iteration may be substantially similar to the actual trajectory 310 of the previous iteration, although the identical trajectories 310 for each iteration 300-306 may not necessarily be identical. For example, during the first iteration 300 at times t1₁, t2₁, t3₁, t4₁, and t5₁, the measured position of the stage is located at positions P₁, P₂, P₃, P₄, and P₅ (hereinafter the “actual position”), respectively. Somewhat similarly, the second iteration 302 includes times t1₂ through t5₂, the third iteration 304 includes times t1₃ through t5₃, and the fourth iteration 306 includes times t1₄ through t3₄. Each of the times t1₂ through t5₂ of the second iteration 302 and the times t1₃ through t5₃ of the third iteration 304 has an actual position that is similar, though not necessarily identical, to a corresponding actual position P₁ through P₅, respectively. Each of the times t1₄ through t3₄ of the fourth iteration 306 has an actual position point that is similar, though not necessarily identical, to a corresponding actual position P₁ through P₃, respectively. It is recognized that the second and third iterations 302, 304, although similar in movement to previous first and second iterations 300, 302, respectively, can vary somewhat as a result of the additional information collected and utilized by the control system 24 and subsequent adjustments that the control system 24 makes in directing current to the one or more mover assemblies to cause forces that more accurately move the stage.

FIG. 3(B) shows an example of the following-error 314 of the stage over the first, second, third, and fourth iterations 300, 302, 304, 306 based on the intended trajectory 312 and the actual trajectory 310 illustrated in FIG. 3(A).

During tuning, a desired trajectory is made and the respective data on position and velocity, for example, of the stage are saved. These data can be applied to the control of subsequent trajectories. It will be understood that the above merely describes an example, and the “similarity” between the actual trajectory of an iteration and the actual trajectory of the previous iteration may be more general. After tuning, for instance, the velocity and shot-size of the stage may be changed.

### Controlled Stage Operation

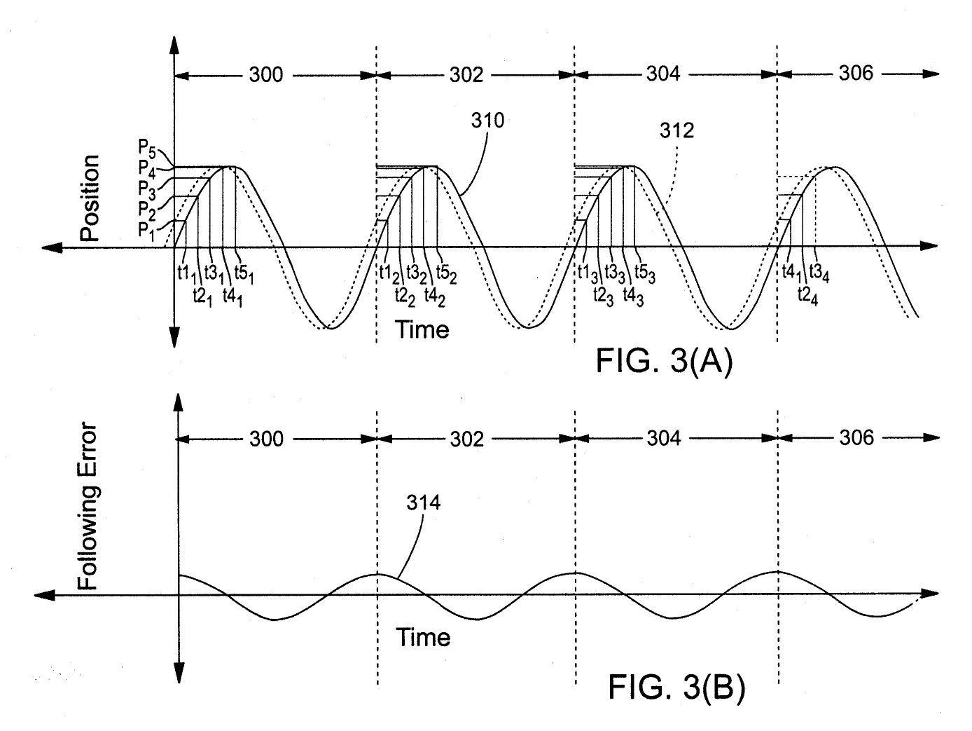

An embodiment of a stage-control system is shown in FIG. 4, in which a stage with its actuators is denoted by P, indicating the “plant.” The system includes a feedback controller C, coupled upstream of the stage P, that produces a command output u_{fb} routed to the stage P. The input to the feedback controller C includes data concerning at least a difference of the following-error e of the stage P from the trajectory r. The input to the feedback controller C is also coupled to an “inverse closed loop” that includes an “inverse nominal plant” \hat{P}₀⁻¹ and a controller 100 programmed with an adaptive (learning) algorithm, notably adaptive feed-forward cancellation (AFC) or iterated learning control (ILC). The output of the controller 100 is summed with the output u_{fb} of the feedback controller C. The resulting sum is summed with disturbance d upstream of the stage and input to the stage P. This sum can also be summed with the output of a feed-forward controller G_{FF}, representing an open-loop. In the inverse closed loop, the output of the inverse nominal plant \hat{P}₀⁻¹ is summed with the output of a plant delay 102 that produces a discrete-time delay z^{-d} (where d is number of samples of delay) or a continuous-time delay e^{-t}^{_{d}}^{s}. The input to the plant delay 102 is the output u_{fb} of the feedback controller C. The output error y is coupled back, in a feedback manner, to upstream of the feedback controller C.

A controller (e.g., the feedback controller C controlling position and movement of a stage) in general operates in two control modes, a first control mode and a second control mode, to control motion and positioning of the plant (in this case a stage). In the first control mode the following-error e(t) is input to the feedback controller C(z), which uses the following-error to improve positioning of the stage P. An intended trajectory r(t) of the stage P is established based on the desired path of the stage. The intended trajectory r(t) is relative to at least one axis, such as along the X-axis, along the Y-axis, and/or about the Z-axis (θ_{z}), for example. The intended trajectory r(t) may also include components about the X-axis (θₓ), about the Y-axis (θ_{y}), and/or along the Z-axis, or any combination thereof.

In the first control mode, one or more points in time along the intended trajectory r(t) are compared with corresponding points in time from an actual trajectory of the stage P to determine whether the stage is properly positioned, and to determine whether the stage will be properly positioned in the immediate future. The actual trajectory is determined by a measurement system (e.g., item 22 in FIG. 1) associated with the stage P and that generates a sensor signal. The measurement system measures the current position of the stage P, and thus of the object (e.g., item 26 in FIG. 1), relative to another structure (e.g., the assembly 16 in FIG. 1). The sensor signals are routed to one or more controllers including the feedback controller C(z). Each sensor signal provides data relating to the actual position of the stage P in one or more degrees of freedom at a specific point in time. The following-error e(t) for the stage is determined by computing the difference between the intended trajectory r(t) and the actual trajectory y(t) at a specific point in time. Based at least on the magnitude of the following-error e(t), the control law (transfer-function) of the controller C(z) determines the extent to which electrical current being (or to be) supplied to one or more mover assemblies of the stage P should be adjusted, if at all.

After the control law determines the current, the current is distributed as a “force command” u(t) to the one or more mover assemblies of the stage P, as appropriate. The mover assemblies then move the stage P, causing it to emulate more accurately the intended trajectory r(t). Data on the position of the stage, or object thereon, is then compared with a corresponding position based on the trajectory r(t) to increase positioning accuracy. The first control mode may continue in this manner until completion of the present iteration. Upon commencing a subsequent iteration, new data regarding the following-error e(t) is generated from data obtained in the current iteration. The new data is used in a similar manner in the first control mode as described above.

The control system also has a second control mode in which a learning algorithm in the feedback controller C(z) collects and assimilates input data to determine the appropriate amount of current to supply to the stage-mover assemblies to move the stage P with increased accuracy. The second control mode can compensate for one or more types of repetitive activities. These repetitive activities can include position-dependent activities such as following-errors e(t) and/or periodical, time-dependent disturbances d(t) and/or noise v(t).

The second control mode may include the first control mode and/or a position-compensation system or module in which one or more steps are executed that further increase the accuracy of movement and positioning of the stage. These steps may vary, and may include receiving and processing data from previous iterations to progressively decrease the following-error e(t) and/or offset the effects of any vibration disturbances of the mechanical system in the current and future iterations.

For the learning algorithm, input data from one or more iterative movements of the stage are collected and provided to a controller memory for use during future iterations. The input data may include the intended trajectory r(t) at various points in time and/or may include the following-error e(t) of the stage. Data on the intended trajectory r(t) and data on the following-error e(t) can be stored in the controller memory. The input data to the learning algorithm may also include a compilation of following-errors from two or more stages, termed a “synchronization error.” The synchronization error is a measurement of how accurately two or more stages are moving or positioning relative to each other, compared with the respective intended trajectories of the stages. The input data to the learning algorithm may include, from one or more iterations, the actual position of the stage at various points in time along the actual trajectory. The input data may further include data relating to the current being directed to the mover assemblies of the stage during previous iterations and/or during the current iteration. The input data may include stage-positioning data, which can include sensor data, provided to the memory. Input data in the form of force-command data can also be provided to the memory, at a time such as immediately following application of feedback control by the first control mode, i.e., before controllably delivering current to the one or more mover assemblies of the stage.

Moreover, since the stage is movable with one or more degrees of freedom, the input data for the learning algorithm supplied to the memory can pertain to movements along each of the applicable principal axes over one or more iterations. After a sufficient amount of input data has been received by the memory, the data is processed by the controller. During data processing, useful information is extracted from the input data that has been collected in the memory. The input data can be transformed as necessary into processed data that can be utilized by the control system to move and position the stage more accurately.

Data processing also can include a periodic evaluation of the performance of the control system to determine whether any of various parameters controlled and/or utilized by the controller need to be further updated. For example, after the following-errors from multiple iterations converge to below a predetermined threshold (which can vary), updating of one or more parameters can be temporarily suspended until the following-errors again exceed the threshold, at which point the parameters can again be updated.

Following data processing, a control law for the controller is determined, revised, or updated by the system. The control law is applied to the processed input data of the learning algorithm. The control law usually is a function of time and any of various other parameters. The system may also include means allowing one or more portions of the system to be turned on or off as necessary.

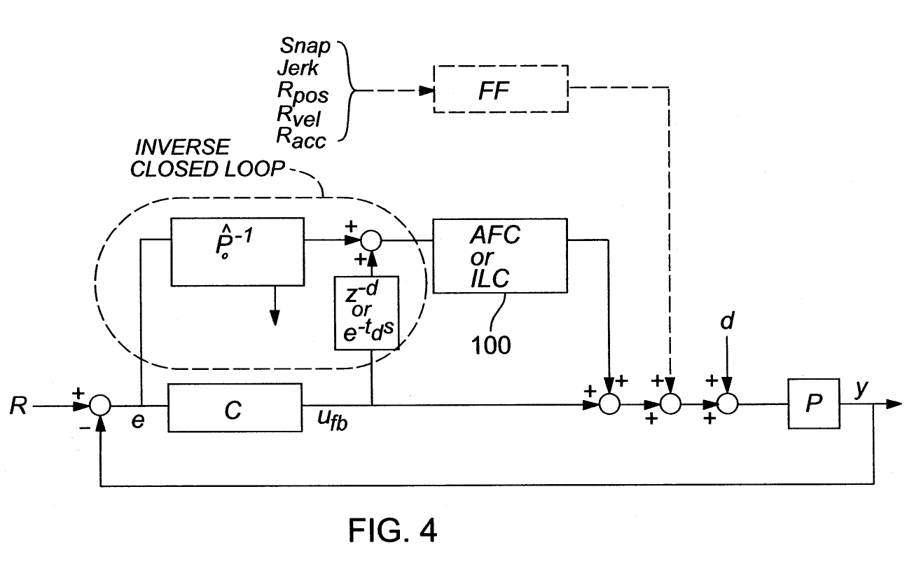

Further general information concerning controlled stage motion can be found in, for example, FIGS. 5A and 5B and respective text in paragraphs [0052]-[0061] of U.S. Patent Publication No. 2005/0231706, incorporated herein by reference.

Referring again to FIG. 4, various embodiments comprise an inverse closed loop. The inverse closed loop includes the inverse nominal plant \hat{P}₀⁻¹ and a controller programmed to perform its control task in an iterative learning manner. Specifically, the controller can be programmed to execute its control in the manner of adaptive feed-forward cancellation (AFC) or in the manner of iterative learning control (ILC). Use of AFC and ILC in these control schemes is described in detail below.

### Control Systems Including Adaptive Feed-Forward Canceller (AFC)

An adaptive feed-forward canceller (AFC) as used herein suppresses periodic following-errors caused either by disturbance forces or by a periodical position reference. Suppression is achieved by destructive interference of at least two signals having respective amplitudes and phases. E.g., a cancellation signal and a following-error signal, by vector addition of the two signals, produce a net reduced following-error. As the name implies, AFC is “adaptive” and thus includes a learning algorithm. Learning occurs over multiple iterations.

To suppress a periodical disturbance d having frequency w within a closed-loop bandwidth:

d(t)=c(t)·cos(wt+φ(t)), (1)

the AFC, which produces an output u_{AFC}(t), may be used as follows. During cancellation, u_{AFC}(t)+d(t)=0 or u_{AFC}(t)=−d(t). Substituting Equation (1) into these expressions yields:

u_{AFC}(t)=−c(t)·cos(wt+φ(t))=a(t)·cos(wt)+b(t)·sin(wt) (2)

in which a(t) and b(t) are discussed below. For tracking a target position having periodical components, AFC may also provide the required periodical control components. See FIGS. 5(A) and 5(B), showing two configurations using an AFC to suppress periodical disturbances. In FIG. 5(A), a shaping filter G_{shaping} providing AFC is upstream of the feedback controller C; in FIG. 5(B), the shaping filter G_{shaping} providing AFC is downstream of the feedback controller C.

The appearance of both sine and cosine terms in Equation (2) encompasses both the amplitude and phase of a sinusoidal function, in view of a(t)=−c(t)·cos(φ(t)) and b(t)=−c(t)·sin(φ(t)). Parameter-updating laws (Equations (3A) and (4A) below), may be used to accommodate the time-variant amplitude and phase terms in Equation (2):

\dot{a}(t)=g·u(t)·cos(wt) (3A)

\dot{b}(t)=g·u(t)·sin(wt) (4A)

Here u(t) represents the following-error e(t) and the output u_{fb}(t) from the feedback-controller C(s).

The transfer-function of this AFC may be derived as follows. Since e^{jwt}=cos(wt)+j sin(wt), the sine and cosine functions may be represented as respective exponential functions:

$$\begin{matrix}cos ( wt ) = \frac{1}{2} ( {e}^{j wt} + {e}^{- j wt} ) & ( 5 ) \\ sin ( wt ) = \frac{1}{2 j} ( {e}^{j wt} - {e}^{- j wt} ) & ( 6 )\end{matrix}$$

Using the time-domain Equations (5) and (6) and the Laplace transform F(s+a) for the time function e^{-at}f(t), Equations (3A), (4A), and (2) become Laplace-domain Equations (7), (8), and (9), respectively:

$$\begin{matrix}A ( s ) = \frac{g}{2 s} ( U ( s - j w ) + U ( s + j w ) ) & ( 7 ) \\ B ( s ) = \frac{g}{2 j s} ( U ( s - j w ) - U ( s + j w ) ) & ( 8 ) \\ {U}_{AFC} ( s ) = \frac{1}{2} ( \begin{matrix}A ( s - j w ) + \\ A ( s + j w )\end{matrix} ) + \frac{1}{2 j} ( \begin{matrix}B ( s - j w ) - \\ B ( s + j w )\end{matrix} ) & ( 9 )\end{matrix}$$

Substituting A(s) and B(s) in Equation (9) with Equations (7) and (8), respectively, the following Equation (10) is obtained:

$$\begin{matrix}{U}_{AFC} ( s ) = \frac{g}{4} ( \frac{1}{s - j w} \cdot ( U ( s - j2 w ) + U ( s ) ) + \\ \frac{1}{s + j w} \cdot ( U ( s ) + U ( s + j2 w ) ) ) - \\ \frac{g}{4} ( \frac{1}{s - j w} \cdot ( U ( s - j2 w ) - U ( s ) ) - \\ \frac{1}{s + j w} \cdot ( U ( s ) - U ( s + j2 w ) ) ) \\ = \frac{g}{4} ( \frac{2}{s - j w} + \frac{2}{s + j w} ) \cdot U ( s ) \\ = \frac{gs}{{s}^{2} + {w}^{2}} \cdot U ( s )\end{matrix} \qquad ( 10 )$$

The AFC transfer-function is a linear time-invariant filter as described in Equation (11A):

$${G}_{AFC} ( s ) = \frac{gs}{{s}^{2} + {w}^{2}} \qquad ( 11 A )$$

Incorporating the AFC yields a serial filter G_{shaping}(s) as follows:

$${G}_{shaping} ( s ) = 1 + {G}_{AFC} ( s ) = \frac{{s}^{2} + gs + {w}^{2}}{{s}^{2} + {w}^{2}} \qquad ( 12 A )$$

To accommodate the phase-delay in the response of the closed-loop system with the aim of accelerating the convergence of parameter adaptation, phase-ahead may be applied to the parameter-updating laws as follows:

\dot{a}(t)=g·u(t)·cos(wt+θ) (3B)

\dot{b}(t)=g·u(t)·sin(wt+θ) (4B)

The phase-ahead equals the phase of the closed-loop transfer-function at the target frequency w, i.e.,

$${θ = ∠ \frac{PC}{1 + PC} \vert}_{s = jw} .$$

Thus, the AFC transfer-function and the corresponding shaping filter may be generalized as:

$$\begin{matrix}{G}_{AFC} ( s ) = \frac{g \cdot ( cos θ \cdot s + w sin θ )}{{s}^{2} + {w}^{2}} & ( 11 B ) \\ {G}_{shaping} ( s ) = 1 + {G}_{AFC} ( s ) = \frac{{s}^{2} + ( g \cdot cos θ ) s + ( {w}^{2} + gw sin θ )}{{s}^{2} + {w}^{2}} & ( 12 B )\end{matrix}$$

The AFC and its equivalent linear time-invariant filter are derived to suppress vibrations within the closed-loop bandwidth. Below is a generalization of its formulation for a vibration-frequency range (within and beyond the closed-loop bandwidth).

The AFC can include a notch-filter G_{notch}(s) added to the default transfer-function. The notch-filter works on disturbances to the following-error, expressed below, at the target vibration frequencies w to attenuate the vibration magnitudes of the following-error:

$$\frac{E ( s )}{D ( s )} = \frac{- P}{1 + PC ( 1 + {G}_{AFC} )} ≡ \frac{- P}{{\underbrace{1 + PC}}_{default E ( s ) / D ( s )}} \cdot {G}_{notch} \qquad ( 13 )$$

This configuration simultaneously also notches down the transfer-function from reference to following-error (so-called closed-loop sensitivity) at the same frequency:

$$\frac{E ( s )}{R ( s )} = \frac{1}{1 + PC ( 1 + {G}_{AFC} )} ≡ \frac{1}{{\underbrace{1 + PC}}_{default E ( s ) / R ( s )}} \cdot {G}_{notch} \qquad ( 14 )$$

From either Equation (13) or (14), the AFC configuration is derived as follows:

$${G}_{AFC} = {( \frac{PC}{1 + PC} )}^{- 1} ( {G}_{notch}^{- 1} - 1 ) . \qquad ( 15 )$$

Note the inverse term

$${( \frac{PC}{1 + PC} )}^{- 1} .$$

Equation (15) is a general form of AFC, for all target frequencies. The consequent closed-loop transfer-function may be represented as follows:

$$\frac{Y ( s )}{R ( s )} = \frac{PC}{{\underbrace{1 + PC}}_{default Y ( s ) / R ( s )}} + \frac{1 - {G}_{notch}^{- 1}}{1 + PC} \qquad ( 16 )$$

For instance, a notch-filter at the target frequency w with a damping ratio d,

$${G}_{notch} ( s ) = \frac{{s}^{2} + {w}^{2}}{{s}^{2} + 2 dws + {w}^{2}} , \qquad ( 17 )$$

leads to the corresponding AFC:

$${G}_{AFC} = {( \frac{PC}{1 + PC} )}^{- 1} \frac{2 dws}{{s}^{2} + {w}^{2}} . \qquad ( 18 )$$

in which

$$\frac{2 dws}{{s}^{2} + {w}^{2}} = {G}_{Notch}^{- 1} - 1.$$

The foregoing can be used not only to suppress periodical disturbances but also to track the periodical reference, as set forth in Equations (13) and (14), respectively. The larger damping ratio d (or equivalently the larger updating gain g) leads to a wider AFC notch bandwidth, which provides faster transients in tracking varying vibration magnitudes and better robustness to target frequency variation. Also, the incorporation of the inverse closed-loop transfer-function in the AFC allows the AFC to have a wider bandwidth without affecting the frequency response too much in the vicinity of the AFC target frequency and the closed-loop bandwidth.

When the target frequency w is within the closed-loop bandwidth frequency,

$${\frac{PC}{1 + PC} \vert}_{s = jw} \approx 1.$$

Based on the notch-filter (Equation (17)), the corresponding AFC may be approximately simplified as:

$${G}_{AFC} ( s ) = {G}_{notch}^{- 1} ( s ) - 1 {=}^{e . g .} \frac{2 dws}{{s}^{2} + {w}^{2}} = \frac{gs}{{s}^{2} + {w}^{2}} . \qquad ( 19 )$$

in which g is the AFC parameter-updating gain, and

$${G}_{Notch}^{- 1} ( s ) = \frac{1}{{G}_{Notch} ( s )} .$$

Note that g=2dw, wherein w is the target frequency and d is the damping ratio of the notch-filter.

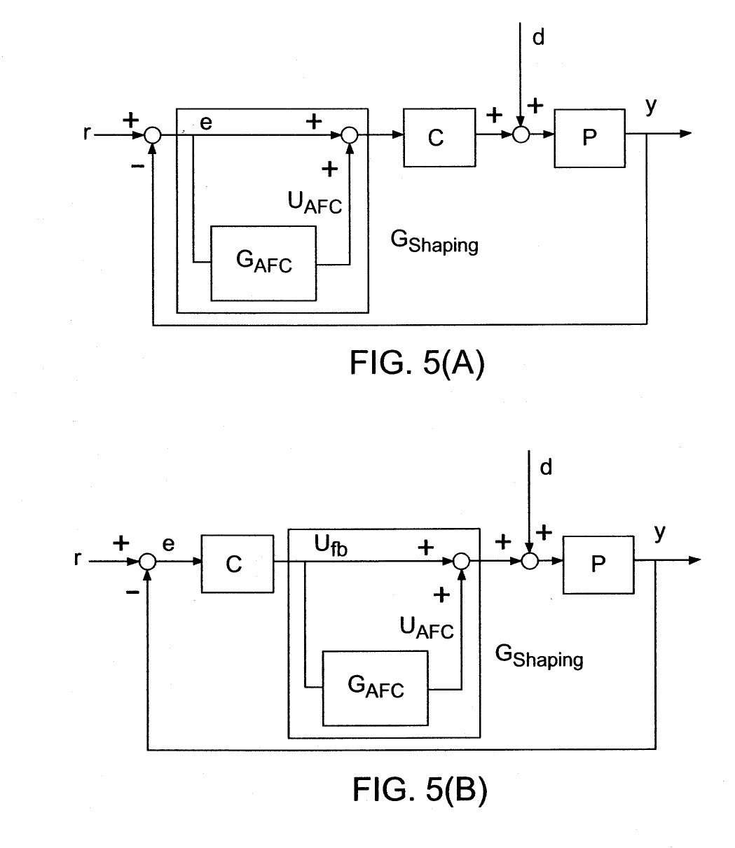

The configurations in FIGS. 5(A)-5(B) may be simplified to the configurations shown in FIGS. 6(A)-6(B), in which the inverse of the notch-filter (G_{Notch}⁻¹) actively suppresses the disturbance. The target frequency is located within the closed-loop bandwidth.

For vibrations at frequencies outside the closed-loop bandwidth, the closed-loop transfer-function may be approximated as:

$${\frac{PC}{1 + PC} \vert}_{s = jw} = \approx \{ \begin{matrix}α & \begin{matrix}if there exists an integer n such that \\ - 90 ° \leq θ + n \cdot 360 ° \leq 90 °\end{matrix} \\ - α & otherwise\end{matrix} \qquad ( 20 )$$

in which

$${\vert \frac{PC}{1 + PC} \vert}_{s = jw} {\vert = α \geq 0 and θ = ∠ \frac{PC}{1 + PC} \vert}_{s = jw}$$

are the magnitude and phase, respectively, of the default closed-loop system at frequency w. The simplified AFC may be implemented as:

$${G}_{AFC} ( s ) = \{ \begin{matrix}\frac{\frac{2 dw}{α} s}{{s}^{2} + {w}^{2}} & \begin{matrix}if there exists an integer n such that \\ - 90 ° \leq θ + n \cdot 360 ° \leq 90 °\end{matrix} \\ \frac{- \frac{2 dw}{α} s}{{s}^{2} + {w}^{2}} & otherwise\end{matrix} \qquad ( 21 )$$

If the magnitude of the closed-loop transfer-function is lumped into the updating gain g or damping ratio d, then the simplified AFC may be further simplified as follows:

$${G}_{AFC} ( s ) = \{ \begin{matrix}\frac{2 dws}{{s}^{2} + {w}^{2}} = \frac{gs}{{s}^{2} + {w}^{2}} & \begin{matrix}if there exists an integer n such \\ that - 90 ° \leq θ + n \cdot 360 ° \leq 90 °\end{matrix} \\ \frac{- 2 dws}{{s}^{2} + {w}^{2}} = \frac{- gs}{{s}^{2} + {w}^{2}} & otherwise\end{matrix} \qquad ( 22 )$$

With these two approximate AFC implementations, some tuning of the damping ratio d (or equivalently of the updating gain g=2dw) can be done to establish a compromise between suppressing vibrations well versus adhering to the sensitivity requirement of the closed-loop.

Equations (11B) and (12B) for the AFC with phase-ahead may be a better-simplified implementation than Equations (19)-(22), since the former consider the phase of the closed-loop transfer-function locally at the target frequency w. Thus, the damping ratio d will be positive for all target frequencies w.

$$\begin{matrix}\begin{matrix}{G}_{AFC} ( s ) = \frac{g \cdot ( cos θ \cdot s + w sin θ )}{{s}^{2} + {w}^{2}} \\ = \frac{2 d cos θ \cdot ws + 2 d sin θ \cdot {w}^{2}}{{s}^{2} + {w}^{2}} , d \geq 0 for all w > 0\end{matrix} & ( 11 B ) \\ \begin{matrix}{G}_{shaping} ( s ) = 1 + {G}_{AFC} ( s ) \\ = \frac{{s}^{2} + ( g \cdot cos θ ) s + ( {w}^{2} + gw \cdot sin θ )}{{s}^{2} + {w}^{2}} \\ = \frac{{s}^{2} + 2 d cos θ \cdot ws + ( 1 + 2 d sin θ ) {w}^{2}}{{s}^{2} + {w}^{2}} , \\ d \geq 0 for all w > 0\end{matrix} & ( 12 B )\end{matrix}$$

Based on Equations (13), (14), and (15), to suppress disturbances at multiple frequencies, multiple notch-filters may be used, each selected for a particular frequency “notch” wᵢ, wherein i=1, 2, 3, . . . , n. The notch-filters may be arranged in series or in parallel.

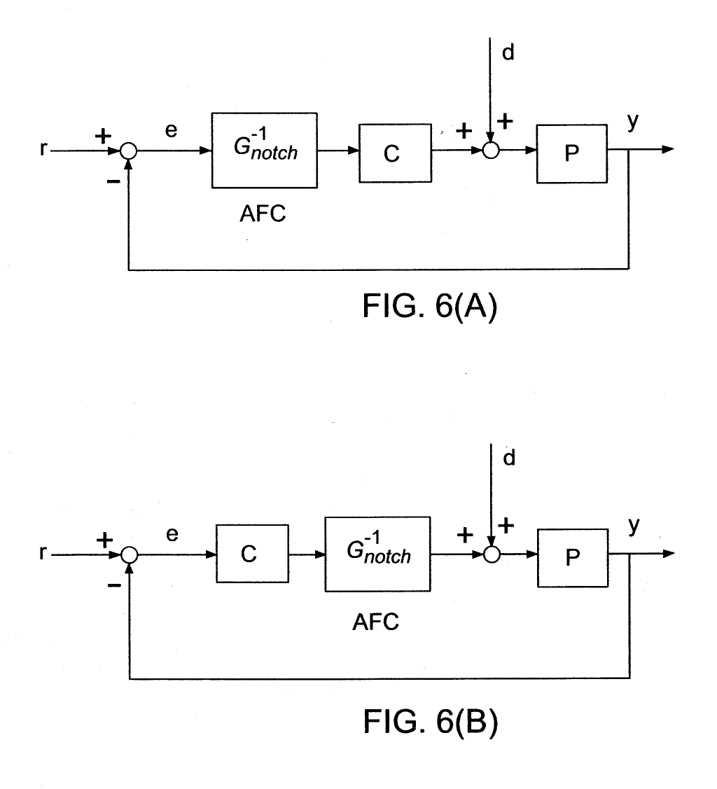

An exemplary configuration in which multiple notch-filters are arranged in series is shown in FIG. 7. Regarding this serial arrangement:

$$\begin{matrix}{G}_{notch} ( s ) = {G}_{notch , w 1} ( s ) \cdot {G}_{notch , w 2} ( s ) \cdot … \cdot {G}_{notch , wn} ( s ) \\ {=}^{e . g .} \underbrace{\frac{{s}^{2} + {w}_{1}^{2}}{{s}^{2} + 2 {d}_{1} {w}_{1} s + {w}_{1}^{2}}}_{{G}_{notch , w 1}} \cdot \underbrace{\frac{{s}^{2} + {w}_{2}^{2}}{{s}^{2} + 2 {d}_{2} {w}_{2} s + {w}_{2}^{2}}}_{{G}_{notch , w 2}} \cdot … \cdot \\ \underbrace{\frac{{s}^{2} + {w}_{n}^{2}}{{s}^{2} + 2 {d}_{n} {w}_{n} s + {w}_{n}^{2}}}_{{G}_{notch , wn}}\end{matrix} \qquad ( 23 )$$

the corresponding serial AFC may be extended as:

$$\begin{matrix}{G}_{AFC} = {( \frac{PC}{1 + PC} )}^{- 1} ( \begin{matrix}{G}_{notch , w 1}^{- 1} ( s ) \cdot \\ {G}_{notch , w 2}^{- 1} ( s ) \cdot … \cdot \\ {G}_{notch , wn}^{- 1} ( s ) - 1\end{matrix} ) \\ {=}^{e . g .} {( \frac{PC}{1 + PC} )}^{- 1} ( \begin{matrix}\underbrace{\frac{{s}^{2} + 2 {d}_{1} {w}_{1} s + {w}_{1}^{2}}{{s}^{2} + {w}_{1}^{2}}}_{{G}_{notch , w 1}^{- 1}} \cdot \\ \underbrace{\frac{{s}^{2} + 2 {d}_{2} {w}_{2} s + {w}_{2}^{2}}{{s}^{2} + {w}_{2}^{2}}}_{{G}_{notch , w 2}^{- 1}} \cdot … \cdot \\ \underbrace{\frac{{s}^{2} + 2 {d}_{n} {w}_{n} s + {w}_{n}^{2}}{{s}^{2} + {w}_{n}^{2}}}_{{G}_{notch , wn}^{- 1}} - 1\end{matrix} )\end{matrix} \qquad ( 24 )$$

This serial AFC (Equation (24)) leads to the following sensitivity function and disturbance rejection:

$$\begin{matrix}\begin{matrix}\frac{E ( s )}{D ( s )} = \frac{- P}{1 + PC ( 1 + {G}_{AFC} )} ≡ \\ \underbrace{\frac{- P}{1 + PC}}_{default E ( s ) / D ( s )} \cdot {G}_{notch , w 1} \cdot {G}_{notch , w 2} \cdot … \cdot {G}_{notch , wn}\end{matrix} & ( 25 ) \\ \begin{matrix}\frac{E ( s )}{R ( s )} = \frac{1}{1 + PC ( 1 + {G}_{AFC} )} ≡ \\ \underbrace{\frac{1}{1 + PC}}_{default E ( s ) / R ( s )} \cdot {G}_{notch , w 1} \cdot {G}_{notch , w 2} \cdot … \cdot {G}_{notch , wn}\end{matrix} & ( 26 )\end{matrix}$$

An appropriate inverse closed-loop transfer-function is especially useful when some of the target frequencies are outside the closed-loop bandwidth.

When all the target frequencies are located within the closed-loop bandwidth,

$${\frac{PC}{1 + PC} \vert}_{s = jw 1 , jw 2 , … , jwn} \approx 1 ,$$

and the serial AFC (Equation (24)) may be simplified:

$$\begin{matrix}{G}_{AFC} = {G}_{notch , w 1}^{- 1} \cdot {G}_{notch , w 2}^{- 1} \cdot … \cdot {G}_{notch , wn}^{- 1} - 1 \\ {=}^{e . g .} \underbrace{\frac{{s}^{2} + 2 {d}_{1} {w}_{1} s + {w}_{1}^{2}}{{s}^{2} + {w}_{1}^{2}}}_{{G}_{notch , w 1}^{- 1}} \cdot \underbrace{\frac{{s}^{2} + 2 {d}_{2} {w}_{2} s + {w}_{2}^{2}}{{s}^{2} + {w}_{2}^{2}}}_{{G}_{notch , w 2}^{- 1}} \cdot … \cdot \\ \underbrace{\frac{{s}^{2} + 2 {d}_{n} {w}_{n} s + {w}_{n}^{2}}{{s}^{2} + {w}_{n}^{2}}}_{{G}_{notch , wn}^{- 1}} - 1\end{matrix} \qquad ( 27 )$$

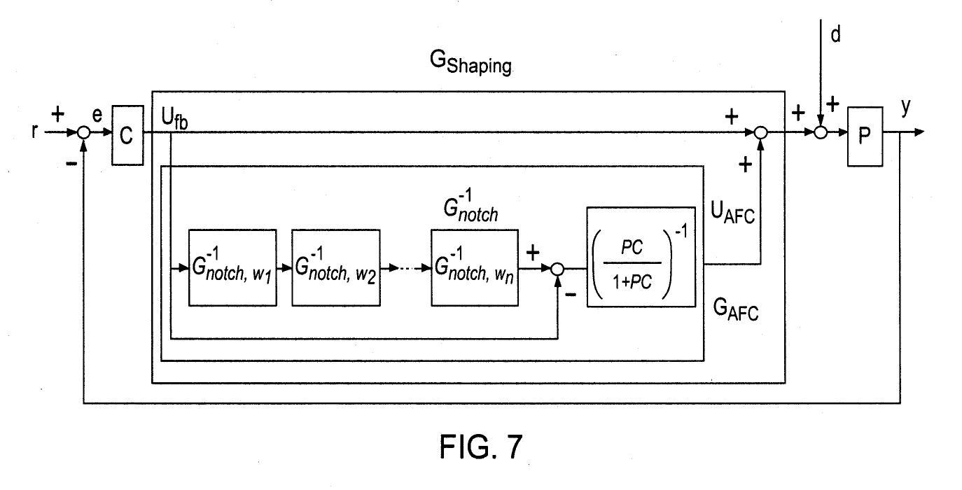

A simplified serial multiple-frequency AFC configuration is shown in FIG. 8.

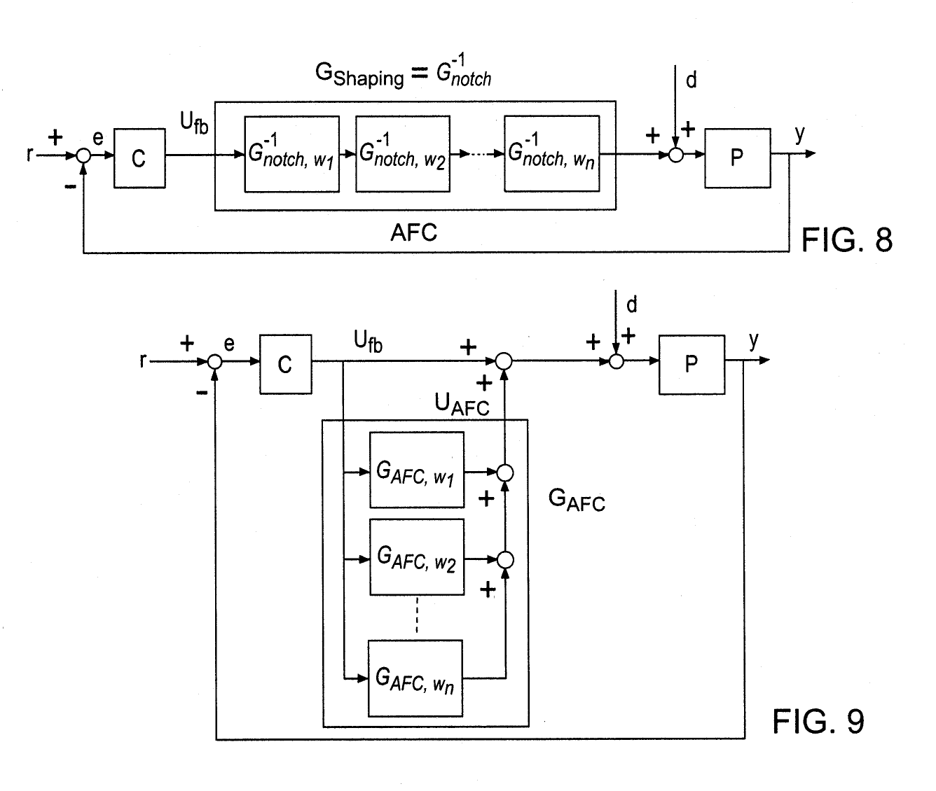

Instead of a serial combination, multiple notch-filters may also be arranged in parallel. An example parallel multiple-frequency AFC configuration is shown in FIG. 9, corresponding to Equation (28).

$$\begin{matrix}{G}_{AFC} ( s ) = \underbrace{{( \frac{PC}{1 + PC} )}^{- 1} ( {G}_{notch , w 1}^{- 1} - 1 )}_{{G}_{AFC} , w 1} + \\ \underbrace{{( \frac{PC}{1 + PC} )}^{- 1} ( {G}_{notch , w 2}^{- 1} - 1 )}_{{G}_{AFC} , w 2} + ... + \\ \underbrace{{( \frac{PC}{1 + PC} )}^{- 1} ( {G}_{notch , wn}^{- 1} - 1 )}_{{G}_{AFC} , wn} \\ {=}^{e . g .} {( \frac{PC}{1 + PC} )}^{- 1} ( \begin{matrix}\underbrace{\frac{{s}^{2} + 2 {d}_{1} {w}_{1} s + {w}_{1}^{2}}{{s}^{2} + {w}_{1}^{2}} - 1}_{{G}_{notch , w 1}^{- 1} - 1} + \\ \underbrace{\frac{{s}^{2} + 2 {d}_{2} {w}_{2} s + {w}_{2}^{2}}{{s}^{2} + {w}_{2}^{2}} - 1}_{{G}_{notch , w 2}^{- 1} - 1} + ... + \\ \underbrace{\frac{{s}^{2} + 2 {d}_{n} {w}_{n} s + {w}_{n}^{2}}{{s}^{2} + {w}_{n}^{2}} - 1}_{{G}_{notch , w n}^{- 1} - 1} \end{matrix} ) \\ = {( \frac{PC}{1 + PC} )}^{- 1} ( \frac{2 {d}_{1} {w}_{1} s}{{s}^{2} + {w}_{1}^{2}} + \frac{2 {d}_{2} {w}_{2} s}{{s}^{2} + {w}_{2}^{2}} + … + \frac{2 {d}_{n} {w}_{n} s}{{s}^{2} + {w}_{n}^{2}} )\end{matrix} \qquad ( 28 )$$

A proper inverse closed-loop transfer-function is advantageous especially when some of the target frequencies are located outside the closed-loop bandwidth.

If all the target frequencies are located within the closed-loop bandwidth,

$${\frac{PC}{1 + PC} \vert}_{s = jw 1 , jw 2 , … , jwn} \approx 1 ,$$

and the parallel AFC may be simplified as follows:

$$\begin{matrix}{G}_{AFC} ( s ) = ( {G}_{notch , w 1}^{- 1} - 1 ) + ( {G}_{notch , w 2}^{- 1} - 1 ) + … + \\ ( {G}_{notch , wn}^{- 1} - 1 ) \\ {=}^{e . g .} \frac{2 {d}_{1} {w}_{1} s}{{s}^{2} + {w}_{1}^{2}} + \frac{2 {d}_{2} {w}_{2} s}{{s}^{2} + {w}_{2}^{2}} + … + \frac{2 {d}_{n} {w}_{n} s}{{s}^{2} + {w}_{n}^{2}}\end{matrix} \qquad ( 29 )$$

In the time domain the above parallel AFC may be described in the equivalent form as follows, which is an extension of Equations (2), (3), and (4):

$${u}_{AFC} ( t ) = {\sum }_{i = 1}^{n} {a}_{i} ( t ) \cdot cos ( {w}_{i} t ) + {b}_{i} ( t ) \cdot sin ( {w}_{i} t ) \qquad ( 30 )$$

with the corresponding parameter-updating laws and parameter-updating gains gᵢ=2dᵢwᵢ:

\dot{a}ᵢ(t)=gᵢ·u(t)·cos(wᵢt) (31A)

\dot{b}ᵢ(t)=gᵢ·u(t)·sin(wᵢt) (32A)

Similar to a single-mode time-domain AFC, the parameter-updating laws for multiple frequencies wᵢ may include phase-ahead to accommodate the original closed-loop system phase lag

$${θ}_{i} = ∠ \frac{PC}{1 + PC} {\vert}_{s = j wi}$$

for quick parameter convergence:

\dot{a}ᵢ(t)=gᵢ·u(t)·cos(wᵢt+θᵢ) (31B)

\dot{b}ᵢ(t)=gᵢ·u(t)·sin(wᵢt+θᵢ) (32B)

Hence, the corresponding parallel AFC may thus be implemented as:

$$\begin{matrix}{G}_{AFC} ( s ) = {G}_{AFC , {w}_{1}} + {G}_{AFC , {w}_{2}} + … + {G}_{AFC , {w}_{n}} \\ = \frac{{g}_{1} ( cos {θ}_{1} \cdot s + {w}_{1} sin {θ}_{1} )}{{s}^{2} + {w}_{1}^{2}} + \\ \frac{{g}_{2} ( cos {θ}_{2} \cdot s + {w}_{2} sin {θ}_{2} )}{{s}^{2} + {w}_{2}^{2}} + … + \\ \frac{{g}_{n} ( cos {θ}_{n} \cdot s + {w}_{n} sin {θ}_{n} )}{{s}^{2} + {w}_{n}^{2}} \\ = \frac{2 {d}_{1} cos {θ}_{1} \cdot {w}_{1} s + 2 {d}_{1} sin {θ}_{1} \cdot {w}_{1}^{2}}{{s}^{2} + {w}_{1}^{2}} + \\ \frac{2 {d}_{2} cos {θ}_{2} \cdot {w}_{2} s + 2 {d}_{2} sin {θ}_{2} \cdot {w}_{2}^{2}}{{s}^{2} + {w}_{2}^{2}} + … + \\ \frac{2 {d}_{n} cos {θ}_{n} \cdot {w}_{n} s + 2 {d}_{n} sin {θ}_{n} \cdot {w}_{n}^{2}}{{s}^{2} + {w}_{n}^{2}}\end{matrix} \qquad ( 33 )$$

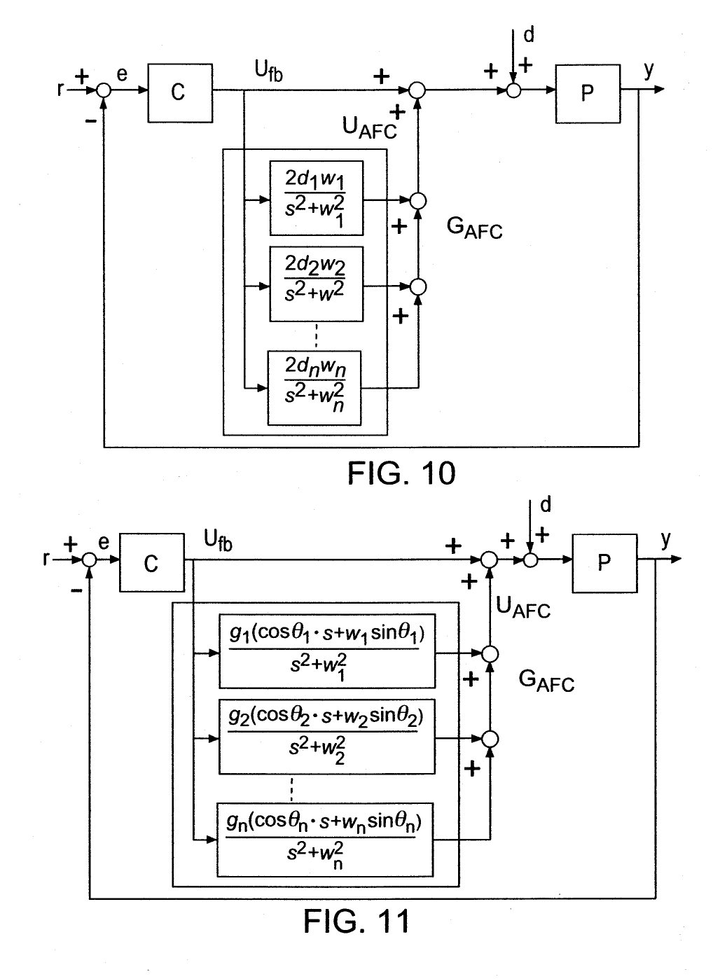

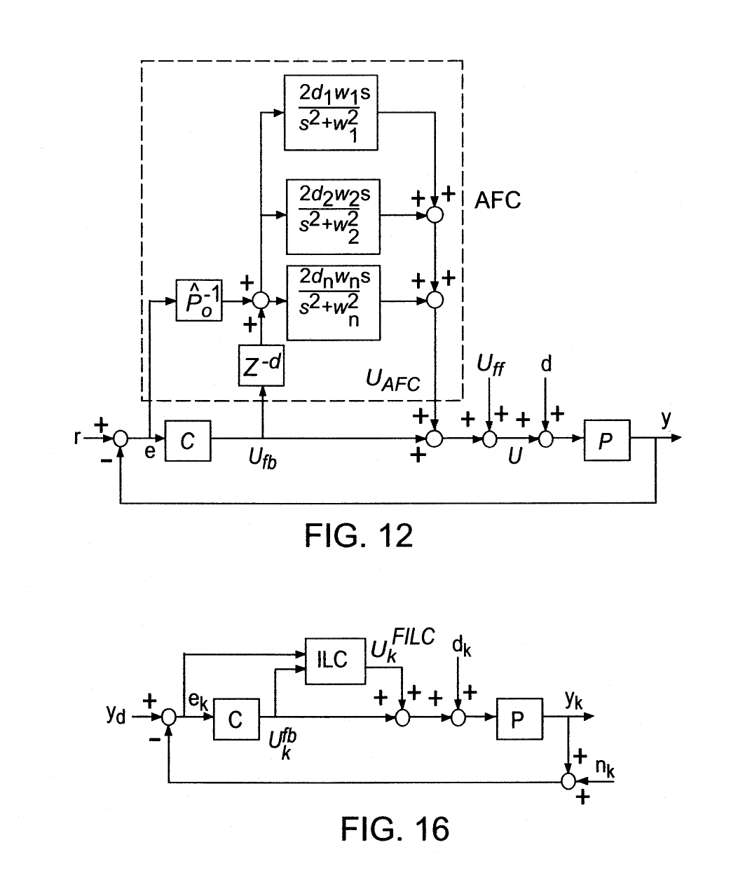

A simplified parallel multiple-frequency AFC is shown in FIG. 10, and the multiple-frequency AFC from which the configuration in FIG. 10 was derived is shown in FIG. 11.

From the foregoing, it can be seen that the AFC suppresses periodical following-errors caused either by disturbance forces or by periodical changes in the reference position. The AFC filters for multiple vibration frequencies may be implemented either in series or in parallel, as discussed above. In certain embodiments, however, the target vibrations are effectively suppressed, but the sensitivity function around the bandwidth is compromised. To balance the effectiveness of low-frequency disturbance rejection versus sensitivity deterioration at the bandwidth, the tuning of AFC filters may be complicated. In the following discussion, the AFC implementation structure is improved to decouple the tunings of the AFC and of other control filters in the control system.

Based on the foregoing, an effective parallel AFC implementation with inverse closed-loop dynamics is:

$${u}_{AFC} = {( \frac{PC}{1 + PC} )}^{- 1} {\sum }_{i = 1}^{N} \frac{2 {d}_{i} {w}_{i} s}{{s}^{2} + {w}_{i}^{2}} \qquad ( 34 )$$

This AFC filter will minimize performance deterioration concerning sensitivity and disturbance rejection in the vicinity of the closed-loop bandwidth and the target vibration frequencies, while providing intended notches right at the target vibration frequencies.

For systems with significant time delay, the implementation of closed-loop inverse dynamics may involve a constrained optimization process for the associated filter parameter search to have stable poles.

As discussed above, AFC can be utilized to suppress periodical following-errors caused by either a disturbance force or a periodical position reference. AFC filters for multiple vibration frequencies can be implemented in either serial or parallel. In the system described below, AFC with inverse closed-loop dynamics (Equation (34)) is implemented, with inputs from both the feedback-control force and the following-error, using an inverse plant model \hat{P}⁻¹.

An effective parallel AFC implementation with inverse closed-loop dynamics is:

$${u}_{AFC} = {( \frac{PC}{1 + PC} )}^{- 1} {\sum }_{i = 1}^{N} ( \frac{2 {d}_{i} {w}_{i} s}{{s}^{2} + {w}_{i}^{2}} ) \qquad ( 35 )$$

in which the sum is of N notch filters for different respective target vibration frequencies and

$$\frac{PC}{1 + PC}$$

is the feedback closed-loop transfer-function. This AFC filter will minimize performance deterioration in sensitivity and disturbance rejection in the vicinities of closed-loop bandwidth and target vibration frequencies, while providing intended notches at the target vibration frequencies. Equation (35) can be further described as follows with inputs from both the feedback-control force u_{fb} and the following-error e, using an inverse plant model \hat{P}⁻¹:

$$\begin{matrix}{u}_{AFC} = {\sum }_{i = 1}^{N} \frac{2 {d}_{i} {w}_{i} s}{{s}^{2} + {w}_{i}^{2}} \cdot {( \frac{\hat{P} C}{1 + \hat{P} C} )}^{- 1} {u}_{fb} \\ = {\sum }_{i = 1}^{N} \frac{2 {d}_{i} {w}_{i} s}{{s}^{2} + {w}_{i}^{2}} \cdot ( 1 + {\hat{P}}^{- 1} {C}^{- 1} ) \cdot {u}_{fb} \\ = {\sum }_{i = 1}^{N} \frac{2 {d}_{i} {w}_{i} s}{{s}^{2} + {w}_{i}^{2}} \cdot ( {u}_{fb} + {\hat{P}}^{- 1} \cdot e )\end{matrix} \qquad ( 36 )$$

Above, note that

$$e = {C}^{- 1} {u}_{fb} and {( \frac{\hat{P} C}{1 + \hat{P} C} )}^{- 1} = ( 1 + {\hat{P}}^{- 1} {C}^{- 1} ) .$$

For a plant P having a delay of t_{d} second,

P=e^{-s·t}^{_{d}}·P₀ (37)

(where P₀ is an actual plant having no delay), the inverse dynamics \hat{P}⁻¹ require time-ahead z^{d}, with

$$d \approx \frac{{t}_{d}}{{T}_{s}} .$$

This can be difficult to implement in real time:

\hat{P}⁻¹=z^{d}·\hat{P}₀⁻¹ (38)

in which \hat{P}₀⁻¹ is the inverse nominal plant without consideration of delay.

Therefore, instead of the AFC configuration,

$${u}_{AFC} = {\sum }_{i = 1}^{N} \frac{2 {d}_{i} {w}_{i} s}{{s}^{2} + {w}_{i}^{2}} \cdot ( {u}_{fb} + {z}^{d} \cdot {\hat{P}}_{0}^{- 1} \cdot e ) \qquad ( 39 )$$

AFC can be implemented with delayed feedback force, as described below, to synchronize the timing between the two inputs of following-error and feedback-force. This manner of achieving a time-delay can be found in the disturbance observer.

$${u}_{AFC} ≡ {\sum }_{i = 1}^{N} \frac{2 {d}_{i} {w}_{i} s}{{s}^{2} + {w}_{i}^{2}} \cdot ( {z}^{- d} \cdot {u}_{fb} + {\hat{P}}_{0}^{- 1} \cdot e ) \qquad ( 40 )$$

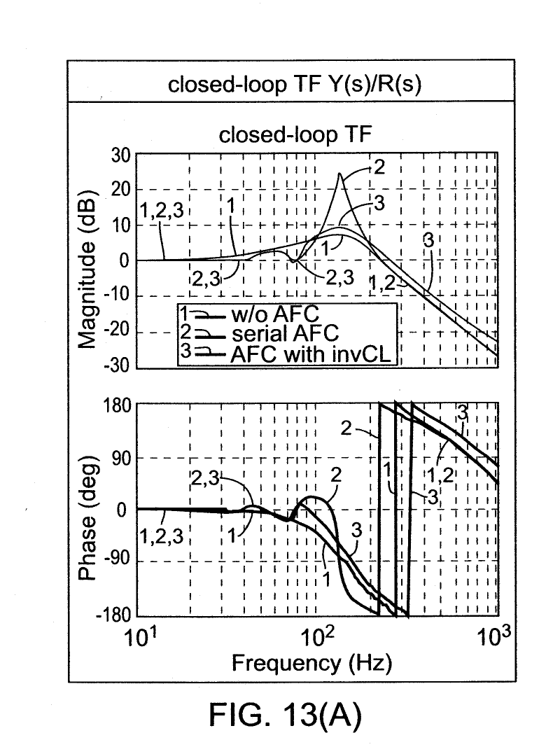

This configuration is shown in FIG. 12. To compensate for stage vibrations at low frequency, the inverse plant model \hat{P}₀⁻¹ without consideration of delay can be implemented as follows, with stage-mass properties and a second-order low-pass filter.

$${\hat{P}}_{0}^{- 1} = \frac{{ms}^{2}}{\frac{{s}^{2}}{{w}^{2}} + 2 d \frac{s}{w} + 1} \qquad ( 41 )$$

### Example 1

The parallel AFC filters used in this example have the following form:

$${G}_{AFC ( w , d )} = \frac{2 \cdot d \cdot \frac{s}{w}}{\frac{{s}^{2}}{{w}^{2}} + 2 \cdot ( 0 ) \cdot \frac{s}{w} + 1} \qquad ( 42 )$$

For comparison, serial AFC shaping filters are used:

$${H}_{AFC ( w , d )} = \frac{\frac{{s}^{2}}{{w}^{2}} + 2 \cdot d \cdot \frac{s}{w} + 1}{\frac{{s}^{2}}{{w}^{2}} + 2 \cdot ( 0 ) \cdot \frac{s}{w} + 1} \qquad ( 43 )$$

For a valid comparison, a parallel AFC filter without inverse closed-loop dynamics has exactly the same effectiveness as a serial AFC filter because:

1+G_{AFC(w,d)}=H_{AFC(w,d)} (44)

In this example a wafer-stage was evaluated, at 140-Hz bandwidth, with four sample time-delays (4*96×10⁻⁶ seconds). Three cases were compared: (1) default system (lacking AFC); (2) system including serial AFC with two shaping filters H_{AFC(40 Hz, 0.2)} and H_{AFC(80 Hz, 0.15)}; and (3) system including AFC with inverse closed-loop dynamics.

AFC: G_{AFC(40 Hz, 0.2)}, G_{AFC(80 Hz, 0.15)}

Inverse plant:

$${\hat{P}}_{0}^{- 1} = \frac{{ms}^{2}}{\frac{{s}^{2}}{{( 4000 \cdot 2 π )}^{2}} + 2 \cdot ( 0.3 ) \frac{s}{( 4000 \cdot 2 π )} + 1}$$

Delay for feedback force: d=4.

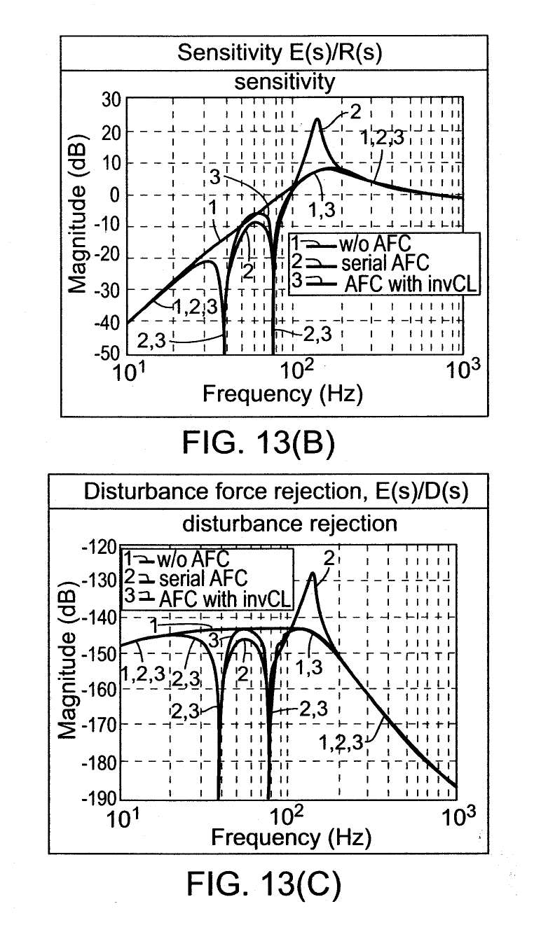

Results are shown in FIGS. 13(A)-13(C). In this example, much less deterioration of sensitivity resulted from parallel AFC filters with inverse closed-loop dynamics than from the serial AFC shaping filters.

### Example 2

In this example a reticle-stage was evaluated, at 300-Hz bandwidth with four sample time-delays (4*96×10⁻⁶ seconds). Three cases were compared: (1) without AFC (default system); (2) serial AFC configuration with two shaping filters, H_{AFC(70 Hz, 0.2)} and H_{AFC(140 Hz, 0.15)}; and (3) AFC with inverse closed-loop dynamics.

Parallel AFC: G_{AFC(70 Hz,0.2)}, G_{AFC(140 Hz, 0.15)}

Inverse plant:

$${\hat{P}}_{0}^{- 1} = \frac{{ms}^{2}}{\frac{{s}^{2}}{{( 4000 \cdot 2 π )}^{2}} + 2 \cdot ( 0.3 ) \frac{s}{( 4000 \cdot 2 π )} + 1}$$

Delay for feedback force: d=4.

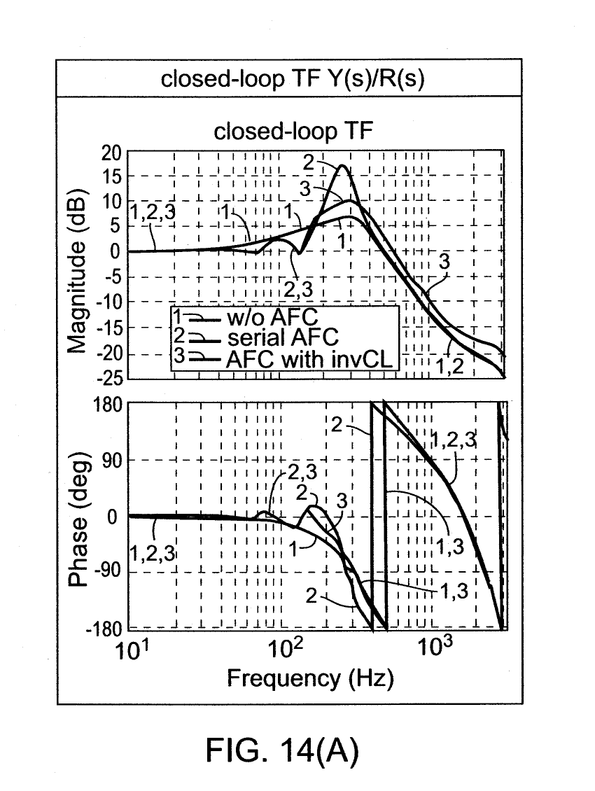

Results are shown in FIGS. 14(A)-14(C). The results are similar to the results obtained in Example 1. Parallel AFC filters having inverse closed-loop dynamics produce much less sensitivity deterioration at bandwidth frequency than serial AFC shaping filters. Consequently, tuning of the AFC may be more independent of other control filters, such as synchronization notch filters.

Control Systems Including Iterative Learning Control (ILC)

Iterative Learning Control (ILC) is advantageous for controlling systems that operate in a repetitive manner. By storing, recalling, and using information from previous iterations of the controlled operation, a suitable control action is determined and applied to each subsequent iteration.

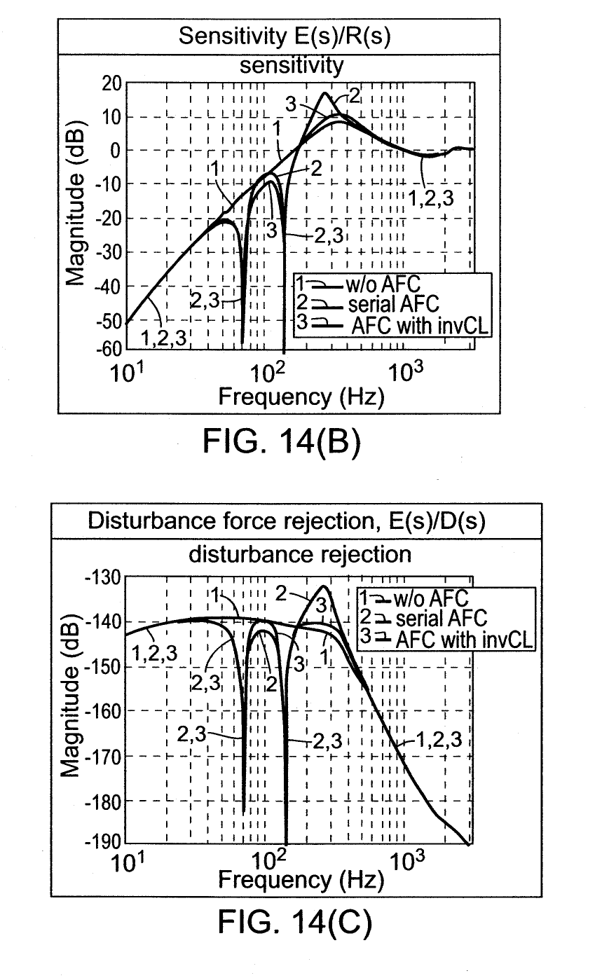

One manner in which an ILC controller can be utilized in a control system is shown in FIG. 15(A), in which the ILC controller has an error input eₖ and a force output uₖ^{FILC}. In this configuration the ILC control law for iteration k is:

uₖ₊₁^{FILC}=uₖ^{FILC}+Q·L·eₖ (45)

in which Q is a low-pass filter as illustrated in FIG. 15(D), and L is a feed-forward filter as illustrated in FIG. 15(D). The error propagation from iteration k to iteration k+1 is:

$$( 46 )$$

$${e}_{k + 1} = ( 1 - \frac{P}{PC} Q \cdot L ) {e}_{k} + \frac{P}{1 + PC} ( {d}_{k} - {d}_{k + 1} ) + \frac{1}{1 + PC} ( {n}_{k} - {n}_{k + 1} )$$

in which dₖ is disturbance in iteration k, dₖ₊₁ is disturbance in iteration k+1, nₖ is noise in iteration k, and nₖ₊₁ is noise in iteration k+1. The convergence condition is:

$$\vert 1 - \frac{P}{1 + PC} Q \cdot L \vert < 1 ; and \qquad ( 47 )$$

for rapid convergence the ideal ILC feed-forward filter in this configuration is:

$$L = {( \frac{P}{1 + PC} )}^{- 1} = {P}^{- 1} + C \qquad ( 48 )$$

in which P⁻¹ is “inverse plant” (1/P). The equivalent ILC command (with the ideal feed-forward filter) is:

uₖ₊₁^{FILC}=uₖ^{FILC}+Q(\hat{P}⁻¹eₖ+C·eₖ)=uₖ^{FILC}+Q(\hat{P}⁻¹eₖ+uₖ^{fb}). (49)

Two other control systems including ILC are shown in FIGS. 15(B) and 15(C), respectively. The configuration of FIG. 15(B) has force input and force output, and the configuration of FIG. 15(C) has error input and error output. The ILC control laws for iteration k are:

FIG. 15(B): uₖ₊₁^{FILC}=uₖ^{FILC}+Q·L·uₖ^{fb} (50)

FIG. 15(C): uₖ₊₁^{EILC}=uₖ^{EILC}+Q·L·eₖ (51)

For both configurations, the error propagation from iteration k to iteration k+1 is:

$${e}_{k + 1} = ( 1 - \frac{P}{1 + PC} Q \cdot L ) {e}_{k} + \frac{P}{1 + PC} ( {d}_{k} - {d}_{k + 1} ) + \frac{P}{1 + PC} ( {n}_{k} - {n}_{k + 1} ) ; \qquad ( 52 )$$

the convergence condition is:

$$\vert 1 - \frac{PC}{1 + PC} Q \cdot L \vert < 1 ; and \qquad ( 53 )$$

the ideal ILC feed-forward filter is:

$$L = {( \frac{PC}{1 + PC} )}^{- 1} = {P}^{- 1} {C}^{- 1} + 1. \qquad ( 54 )$$

For rapid convergence the equivalent ILC commands (with ideal feed-forward filter) are:

FIG. 15(B): uₖ₊₁^{FILC}=uₖ^{FILC}+Q(\hat{P}⁻¹C⁻¹uₖ^{fb}+uₖ^{fb})=uₖ^{FILC}+Q(\hat{P}⁻¹eₖ+uₖ^{fb}) (55)

FIG. 15(C): uₖ₊₁^{EILC}=uₖ^{EILC}+Q(\hat{P}⁻¹C⁻¹eₖ+eₖ) (56)

in which \hat{P}⁻¹ is the inverse plant model. As transformed into force ILC, the ILC force command for FIG. 15(C) is:

[symbol]

C·[uₖ₊₁^{EILC}=uₖ^{EILC}+Q(\hat{P}⁻¹C⁻¹eₖ+eₖ^{fb})]

[symbol]

uₖ₊₁^{FILC}=uₖ^{FILC}+Q(\hat{P}⁻¹eₖ+uₖ^{fb})

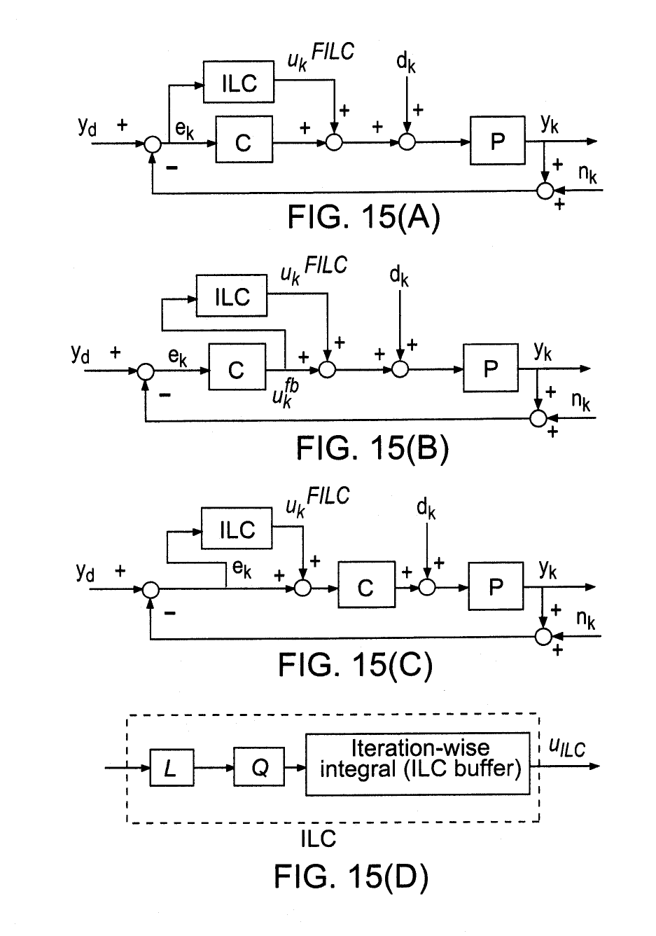

An ILC-including system in which the configurations of FIGS. 15(B) and 15(C) are combined is shown in FIG. 16. With some simple manipulations between following-error and force, such as uₖ^{fb}=Ceₖ and uₖ^{FILC}=Cuₖ^{EILC}, these t configurations for ILC control are actually equivalent, being described in the following common formulation:

uₖ₊₁^{FILC}=uₖ^{FILC}+Q(\hat{P}⁻¹eₖ+uₖ^{fb}) (57)

(From a practical standpoint, the plant model \hat{P} may have to represent the real plant P.)

When incorporating inverse-plant dynamics, in many instances only the plant dynamics within a frequency range of interest need be considered. The frequency range of interest usually is related to the frequency contents of the trajectory and disturbance, and the frequency range can be prescribed by the cutoff frequency of the Q filter later. For instance, for a stage system with well-shaped dynamics, the nominal plant in each axis within the frequency range of interest could be as simple as inertia with some time delay in Equation (n), below:

$$\hat{P} ( s ) = {e}^{- {t}_{d} s} \cdot {\hat{P}}_{0} = {e}^{- {t}_{d} s} \cdot \frac{1}{{ms}^{2}} \qquad ( 58 )$$

A system with higher-order dynamics may include appropriately treated shaping filters. A higher-order plant model would be indicated if high-frequency dynamics could not be ignored even after appropriate shaping filter treatment.

For the convenience of inverse plant dynamics, a low-pass filter Q can be added with a very high cutoff frequency (e.g., 95% of the Nyquist frequency). For a plant having significant high-frequency dynamics, the Q filter cutoff frequency can be lowered to attenuate them.

$${\hat{P}}^{- 1} ( s ) = {e}^{{t}_{d} s} \cdot {\hat{P}}_{0}^{- 1} ( s ) \cdot {H}_{LP} ( s ) = {e}^{{t}_{d} s} \cdot \frac{{ms}^{2}}{\frac{{s}^{2}}{{w}^{2}} + 2 d \frac{s}{w} + 1} \qquad ( 59 )$$

The discrete-time implementation of the inverse plant dynamics is described as follows:

\hat{P}⁻¹(z⁻¹)=z^{k}^{_{d}}·\hat{P}₀⁻¹(z⁻¹)·H_{LP}(z⁻¹) (60)

### Here,

$${k}_{d} = \frac{{t}_{d}}{{T}_{s}}$$

is the estimated number of samples for system delay.

An even-order (e.g., 2n^{th} order) causal symmetric FIR filter (Equation (61), below) may be converted to a zero-phase Q filter by adding n-sample time ahead (half the FIR order) onto the ILC output:

Q̅(z⁻¹)=c₀+c₁z⁻¹+ . . . +cₙz⁻ⁿ+ . . . +c₁z⁻⁽²ⁿ⁻¹⁾+c₀z⁻²ⁿ (61)

Q(z⁻¹)=zⁿ· Q̅(z⁻¹)=c₀zⁿ+c₁zⁿ⁻¹+ . . . +cₙz⁰+ . . . +c₁z⁻⁽ⁿ⁻¹⁾+c₀z⁻ⁿ (62)

Here, the parameters of the Q filter have been normalized with their sum being equal to one.

From a practicality standpoint, it may be desirable that the Q filter include a learning gain k_{ILC} ∈ [0,1] to accommodate system uncertainties and non-repeatable noise and disturbance.

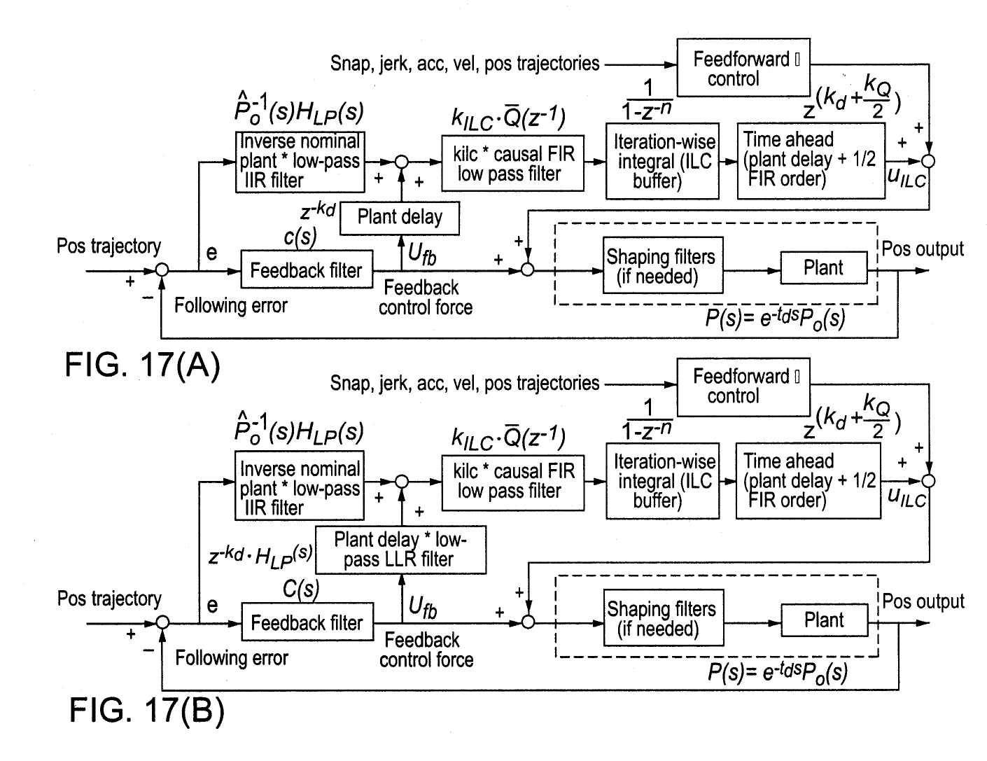

Reference is now made to FIG. 17(A), showing a control system, based on FIG. 16, including an ILC inverse closed-loop without a feedback-force low-pass filter. The position trajectory enters the system on the left, and a following-error e is determined as a difference of the output from the trajectory. The following-error e is routed to the feedback filter C(s) which produces a feedback-control force u_{fb}. The following-error e is also routed to the inverse nominal plant (including a low-pass IIR, or infinite impulse response, filter) \hat{P}₀⁻¹(s)·H_{LP}(s). The feedback-control force u_{fb} is also routed to a plant delay z^{-k}^{_{d}}. The output of the plant delay z^{-k}^{_{d}} is summed with the output of the inverse nominal plant \hat{P}₀⁻¹(s)·H_{LP}(s), and the sum is routed to the ILC controller with FIR, or finite impulse response, low-pass filter k_{ILC}· Q̅(z⁻¹). The output of the ILC controller k_{ILC}· Q̅(z⁻¹) is routed to the ILC buffer (iteration-wise, integral)

$$\frac{1}{1 - {z}^{- N}} ,$$

of which the output is routed to the time-ahead (plant delay+½ FIR order)

$${z}^{( {k}_{d} + \frac{{k}_{g}}{2} )} .$$

The output of the time-ahead

$${z}^{( {k}_{d} + \frac{{k}_{g}}{2} )}$$

is summed with the feedback-control force u_{fb} and input to the plant P(s)=e^{-t}^{_{d}}^{s}P₀(s). Note that the path from the following-error to the inverse nominal plant, ILC controller, ILC buffer, time-ahead, and then to the plant is an inverse closed loop providing an ILC output u_{ILC} to the plant. The inverse closed-loop also includes the plant delay z^{-k}^{_{d}}. The plant P(s) also includes shaping filters if needed. Also summed with the ILC output is the output of a feed-forward controller that receives input including snap, jerk, position trajectory, velocity trajectory, and acceleration trajectory. The position output from the plant P(s) is fed back to provide input to the feedback controller C(s).

With the inverse plant model (Equation (60)) and FIR Q filter (Equation (62)) described above, the ILC control law (Equation (57)) may be rewritten as below for a learning process with N samples for one iteration. Here,

$$\frac{1}{1 - {z}^{- N}}$$

represents the iteration-wise integral, and k is the step number:

$${u}_{ILC} ( k ) = \frac{1}{1 - {z}^{- N}} \cdot {k}_{ILC} \cdot Q ( {z}^{- 1} ) \cdot ( {P}^{- 1} ( {z}^{- 1} ) \cdot e ( k ) + {u}_{fb} ( k ) ) \approx {z}^{\frac{{k}_{Q}}{2}} \cdot \frac{1}{1 - {z}^{- N}} \cdot {k}_{ILC} \cdot \overline{Q} ( {z}^{- 1} ) \cdot ( {z}^{{k}_{4}} \cdot {\hat{P}}_{0}^{- 1} ( {z}^{- 1} ) \cdot {H}_{LP} ( {z}^{- 1} ) \cdot e ( k ) + {u}_{fb} ( k ) ) \approx {z}^{( {k}_{d} + \frac{{k}_{Q}}{2} )} \cdot \frac{1}{1 - {z}^{- N}} \cdot {k}_{ILC} \cdot \overline{Q} ( {z}^{- 1} ) \cdot ( {\hat{P}}_{0}^{- 1} ( {z}^{- 1} ) \cdot {H}_{LP} ( {z}^{- 1} ) \cdot e ( k ) + {z}^{- {k}_{d}} \cdot {u}_{fb} ( k ) ) \qquad ( 63 )$$

The ILC control law (Equation (63)) can be separated into multiple portions as shown in FIG. 17(A).

If the frequency of the IIR filter is not excessively higher than the Q filter, it is possible to keep both ILC input signals (following-error and feedback-force command) substantially at the same relative phase by applying the same low-pass IIR filter to both of them:

$${u}_{ILC} ( k ) = \frac{1}{1 - {z}^{- N}} \cdot {k}_{ILC} \cdot Q ( {z}^{- 1} ) \cdot ( {P}^{- 1} ( {z}^{- 1} ) \cdot e ( k ) + {u}_{fb} ( k ) ) \approx {z}^{\frac{{k}_{Q}}{2}} \cdot \frac{1}{1 - {z}^{- N}} \cdot {k}_{ILC} \cdot \overline{Q} ( {z}^{- 1} ) \cdot ( {z}^{{k}_{d}} \cdot {\hat{P}}_{0}^{- 1} ( {z}^{- 1} ) \cdot {H}_{LP} ( {z}^{- 1} ) \cdot e ( k ) + {H}_{LP} ( {z}^{- 1} ) \cdot {u}_{fb} ( k ) ) \approx {z}^{{k}_{d} + \frac{{k}_{Q}}{2}} \cdot \frac{1}{1 - {z}^{- N}} \cdot {k}_{ILC} \cdot \overline{Q} ( {z}^{- 1} ) \cdot ( {\hat{P}}_{0}^{- 1} ( {z}^{- 1} ) \cdot {H}_{LP} ( {z}^{- 1} ) \cdot e ( k ) + {z}^{- {k}_{d}} \cdot {H}_{LP} ( {z}^{- 1} ) \cdot {u}_{fb} ( k ) ) \qquad ( 64 )$$

This configuration is shown in FIG. 17(B), which is similar to FIG. 17(A) except that an additional low-pass filter is added at plant delay z^{-k}^{_{d}} (now z^{k}^{_{d}}·H_{LP}(s)).

Based on the zero-phase Q filter, learning gain, and the inverse closed-loop models described above, the ILC iteration-wise sensitivity for repeatable following-error attenuation may be used to evaluate the effectiveness of the ILC system:

$$\begin{matrix}I L C iteration sensitivity = {μ}_{iteration - wise\_residual \_error \_ratio} \\ = \vert \begin{matrix}1 - {G}_{closed - loop} ( {z}^{- 1} ) \cdot \\ \underbrace{{k}_{ILC} {\hat{G}}_{closed - loop}^{- 1} ( {z}^{- 1} ) \cdot Q ( {z}^{- 1} )}_{ILC design}\end{matrix} \vert \leq 1\end{matrix} \qquad ( 65 )$$

### Here,

$${\hat{G}}_{closed - loop}^{- 1} ( {z}^{- 1} ) = \{ \begin{matrix}{z}^{d} {\hat{P}}_{0}^{- 1} ( {z}^{- 1} ) {H}_{LP} ( {z}^{- 1} ) {C}^{- 1} ( {z}^{- 1} ) + 1 & \begin{matrix}without feedback \\ force low pass\end{matrix} \\ {z}^{d} {\hat{P}}_{0}^{- 1} ( {z}^{- 1} ) {H}_{LP} ( {z}^{- 1} ) {C}^{- 1} ( {z}^{- 1} ) + {H}_{LP} ( {z}^{- 1} ) & \begin{matrix}with feedback \\ force low pass\end{matrix}\end{matrix}$$

From a slightly different perspective from the foregoing, two feed-forward stage-control schemes including ILC are shown in FIGS. 14(A)-14(B), including following-error ILC and feedback-force ILC, respectively.

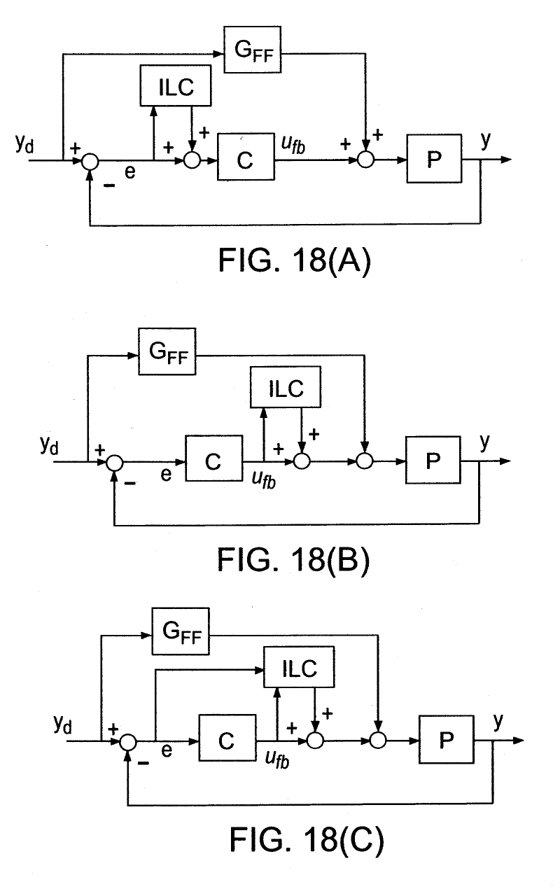

By including inverse closed-loop dynamics, the ILC compensation bandwidth can be extended to a frequency area higher than the closed-loop bandwidth. An ILC configuration in which the configurations of both FIG. 18(A) and FIG. 18(B) are combined is shown in FIG. 18(C), which provides an ILC configuration in which ILC and feedback control are decoupled. As described below, the ILC in FIG. 18(C) generates its output-force command from both the feedback-control force u_{fb} and the following-error e processed by the inverse of a nominal plant model. To shape the plant for improved dynamics, a shaping filter can be placed immediately upstream of the plant. (See also FIGS. 17(A) and 17(B).)

As illustrated by Equation (66), the feedback-control force ILC for the time step k in iteration N comprises several components such as a learning gain k_{ILC} ∈ [0,1], a low-pass zero-phase filter Q̅(z, z⁻¹), and an inverse closed-loop-dynamics filter Ĝ_{closed-loop}⁻¹(z⁻¹):

$${u}_{ILC , N} ( k ) = {\sum }_{j = 0}^{N - 1} {k}_{ILC} \cdot \overline{Q} ( z , {z}^{- 1} ) \cdot {\hat{G}}_{closed - loop}^{- 1} ( {z}^{- 1} ) \cdot {u}_{fb , j} ( k ) \qquad ( 66 )$$

The inverse-closed-loop dynamics may be further simplified as below with a nominal plant model \hat{P}(z⁻¹):

$${\hat{G}}_{closed - loop}^{- 1} ( {z}^{- 1} ) = \frac{1 + \hat{P} ( {z}^{- 1} ) C ( {z}^{- 1} )}{\hat{P} ( {z}^{- 1} ) C ( {z}^{- 1} )} = {\hat{P}}^{- 1} ( {z}^{- 1} ) {C}^{- 1} ( {z}^{- 1} ) + 1 \qquad ( 67 )$$

Substituting Equation (67) into Equation (66), the ILC control-law becomes:

$${u}_{ILC , N} ( k ) = {\sum }_{j = 0}^{N - 1} {k}_{ILC} \cdot \overline{Q} ( z , {z}^{- 1} ) \cdot ( {\hat{P}}^{- 1} ( {z}^{- 1} ) {C}^{- 1} ( {z}^{- 1} ) + 1 ) \cdot {u}_{fb , j} ( k ) \qquad ( 68 )$$

Since c(z⁻¹)·e(z⁻¹)=u_{fb}(z⁻¹) [symbol] c⁻¹(z⁻¹)·u_{fb}(z⁻¹)=e(z⁻¹), the ILC control for the time-step k in iteration N may be revised as follows with inputs from both the following-error and the feedback-force command:

$${u}_{ILC , N} ( k ) = {\sum }_{j = 0}^{N - 1} {k}_{ILC} \cdot \overline{Q} ( z , {z}^{- 1} ) \cdot ( {\hat{P}}^{- 1} ( {z}^{- 1} ) \cdot {e}_{j} ( k ) + {u}_{fb , j} ( k ) ) \qquad ( 69 )$$

Inverse-plant dynamics are implemented, taking into consideration the plant dynamics within the frequency range of interest. For a stage system with well-shaped dynamics, the nominal plant in each axis within the frequency range of interest can be as simple as inertia with some time-delay.

$$\hat{P} ( s ) = \frac{1}{{ms}^{2}} \cdot {e}^{- {i}_{d} s} \qquad ( 70 )$$

For ease of implementation of the inverse plant dynamics, a low-pass filter having very high cutoff frequency (e.g., 1000 Hz or higher) can be added to reduce the plant modeling area at high frequency.

$${\hat{P}}^{- 1} ( s ) = {\hat{P}}_{0}^{- 1} ( s ) \cdot {e}^{{t}_{d} s} = \frac{{ms}^{2}}{\frac{{s}^{2}}{{w}^{2}} + 2 d \frac{s}{w} + 1} \cdot {e}^{{t}_{d} s} \qquad ( 71 )$$

The discrete time implementation, the inverse-plant dynamics can be described as follows:

\hat{P}⁻¹(z⁻¹)=\hat{P}₀⁻¹(z⁻¹)·z^{k}^{_{d}} (72)

in which

$${k}_{d} \approx \frac{{t}_{d}}{{T}_{s}}$$

is the estimated sample number of system delay.

The system of FIG. 17(C) is shown in more detail in FIG. 18. Again, the ILC generates its output-force command from the feedback-control force and the following-error processed by the nominal plant model. The system includes a shaping filter just upstream of the plant to improve plant dynamics.

### Example 3

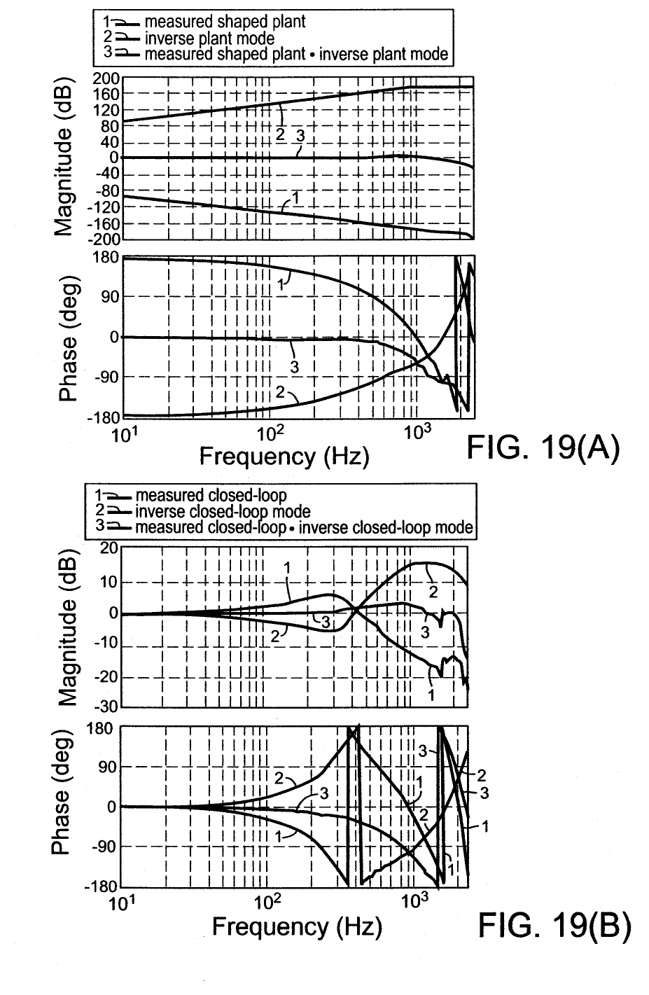

In this example the inverse plant model described above is applied to a reticle stage. Results are shown in FIGS. 19(A)-19(B), which reveal that the plant mode fits the real shaped plant well (FIG. 19(A)). The overall inverse-closed-loop model in this example is good up to 800 Hz (with −90-degree phase indicated).

### Example 4

In this example a k_{Q}^{th}-order, zero-phase filter Q̅(z, z⁻¹) is implemented as a causal FIR filter Q(z⁻¹) with its output value shifted by the step

$$\frac{{k}_{Q}}{2} .$$

For precise implementation, even-order filters are preferred.

$$\overline{Q} ( z , {z}^{- 1} ) = {z}^{\frac{{k}_{Q}}{2}} \cdot Q ( {z}^{- 1} ) \qquad ( 73 )$$

For implementation convenience, the timings of a zero-phase low-pass filter and a plant-time delay may be handled together in an ILC command output. Substituting Equation (73) into Equation (69), an overall ILC command at time step k of iteration N is implemented as follows:

$$\begin{matrix}{u}_{ILC , N} ( k ) = {\sum }_{j = 0}^{N - 1} {k}_{ILC} \cdot \overline{Q} ( z , {z}^{- 1} ) \cdot ( {z}^{{k}_{d}} \cdot {\hat{P}}_{0}^{- 1} ( {z}^{- 1} ) \cdot {e}_{j} ( k ) + {u}_{fb , j} ( k ) ) \\ = {z}^{\frac{{k}_{Q}}{2} + {k}_{d}} \cdot \\ \underbrace{{\sum }_{j = 0}^{N - 1} {k}_{ILC} \cdot Q ( {z}^{- 1} ) \cdot ( {\hat{P}}_{0}^{- 1} ( {z}^{- 1} ) \cdot {e}_{j} ( k ) + {u}_{fb , j} ( k - d ) )}_{ILC buffer}\end{matrix} \qquad ( 74 )$$

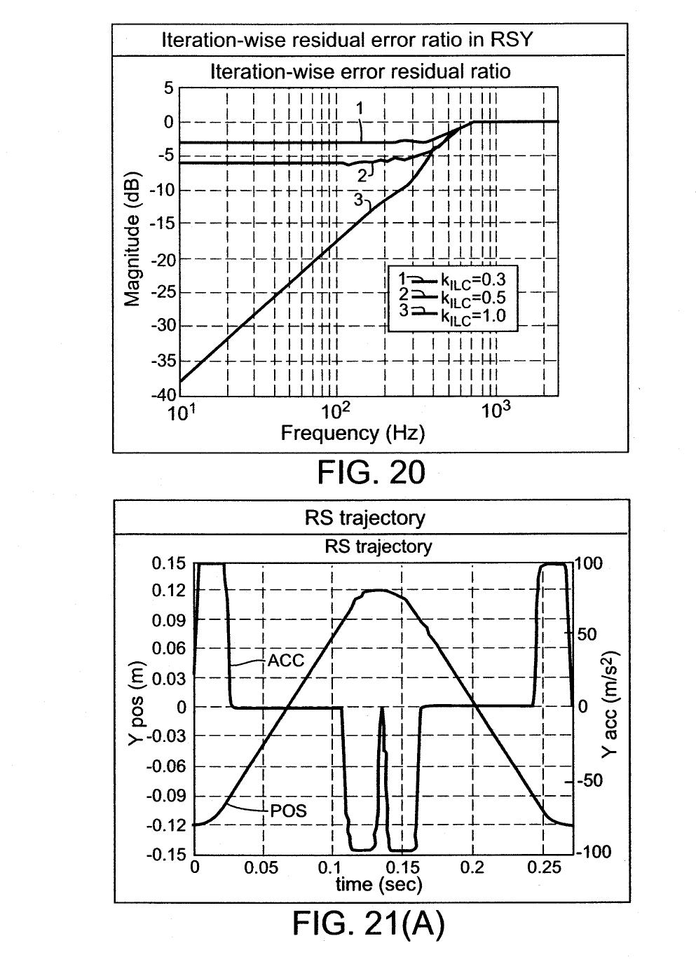

Based on the Q filter and the inverse closed-loop model (resulting from a simple inverse plant model), the ILC convergence condition can be checked for repeatable attenuation of following-error, which is shown in FIG. 20.

$${μ}_{iterationwise\_residual \_error \_ratio} = \vert \begin{matrix}1 - {G}_{closed - loop} ( {z}^{- 1} ) \cdot {k}_{ILC} \cdot \\ {\hat{G}}_{closed - loop}^{- 1} ( {z}^{- 1} ) \cdot Q ( {z}^{- 1} )\end{matrix} \vert \leq 1 for all frequencies \qquad ( 75 )$$

### Example 5

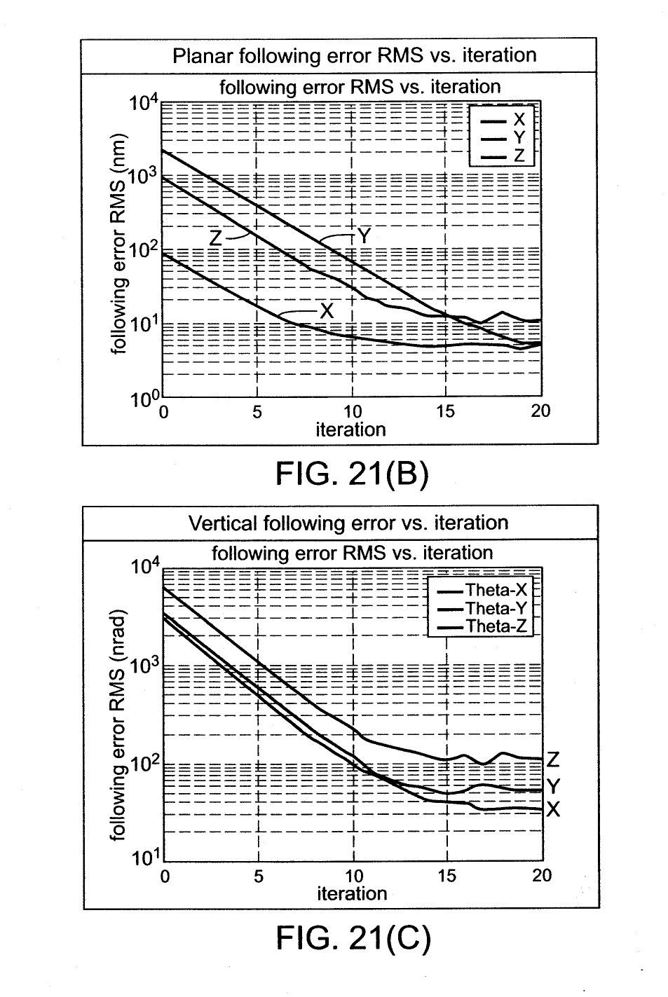

In this example the ILC embodiment is applied to a 6-DOF reticle-stage, which repetitively follows a trajectory as shown in FIG. 21(A). As the ILC learning iteration increases, all the stage following-errors exponentially decrease and then converge to very small values as shown by their root-mean-squares of each iteration in FIGS. 21(B) and 21(C).

### Microlithography System

FIG. 1 is a schematic illustration of a precision system, in this embodiment an exposure apparatus 10, embodying features as discussed above. The exposure apparatus 10 includes an apparatus frame 12, an illumination system 14, an optical assembly 16, a reticle-stage assembly 18, a wafer-stage assembly 20, a measurement system 22, one or more sensors 23, and a control system 24. The respective configurations of the components of the exposure apparatus 10 can be varied to suit the design requirements of the exposure apparatus 10.

It will be understood that the “optical assembly” 16 can include optical and mechanical components. But the assembly 16 in other precision system embodiments may not have any optical components. The assembly 16 can be any of various “process assemblies” or process tools relative to which at least one of the stages 18, 20 positions an object being carried by the stage.

The control system 24 utilizes a position-compensation system that improves the accuracy in the control and relative positioning of at least one of the stage assemblies 18, 20. The control system 24 can include multiple controllers, including stage-motion controllers programmed to control motion of one or more of the stage assemblies.

The exposure apparatus 10 is useful as a lithography tool that transfers a pattern (not shown) of an integrated circuit or other micro-device from a reticle 26 onto a substrate (“wafer”) 28. The exposure apparatus 10 rests on a mounting base 30, e.g., the ground, a base, a floor, or other supporting structure.

There are a number of different types of lithography tools. For example, the exposure apparatus 10 can be used as scanning-type photolithography system that exposes the pattern from the reticle 26 onto the wafer 28 with the reticle 26 and the wafer 28 moving synchronously. In a scanning-type lithography tool, during exposures the reticle 26 is moved perpendicularly to an optical axis of the optical assembly 16 by the reticle-stage assembly 18, and the wafer 28 is moved perpendicularly to the optical axis of the optical assembly 16 by the wafer-stage assembly 20. Meanwhile, scanning of the reticle 26 and the wafer 28 occurs. Synchronous motions of the reticle and wafer are achieved while their respective stage assemblies are being controlled as described above.

Alternatively, the exposure apparatus 10 can be a step-and-repeat type of lithography tool that exposes the wafer 28 while the reticle 26 and the wafer 28 are momentarily stationary. In step-and-repeat exposure, the wafer 28 is in a constant position relative to both the reticle 26 and the optical assembly 16 during exposure of an individual field on the wafer. Between consecutive exposure steps, the wafer 28 is moved using the wafer-stage assembly 20 perpendicularly to the optical axis of the optical assembly 16 to bring the next field of the wafer 28 into position relative to the optical assembly 16 and the reticle 26 for exposure. By repeating this sequence, images of the pattern defined by the reticle 26 are sequentially exposed onto the fields of the wafer 28.

Use of the exposure apparatus 10 provided herein is not limited to a lithography tool for integrated-circuit manufacturing. The exposure apparatus 10, for example, can be used as an LCD photolithography system that exposes a pattern of a liquid-crystal display device onto a rectangular glass plate, for example, or a photolithography system for manufacturing a thin-film magnetic head. Alternatively, the exposure apparatus 10 can be a proximity photolithography system that exposes a pattern from a mask to a substrate with the mask being located close to the substrate without the use of the optical assembly 16.

The apparatus frame 12 is rigid and supports the components of the exposure apparatus 10. The apparatus frame 12 illustrated in FIG. 1 supports the optical assembly 16 and the illumination system 14 above the mounting base 30.

The illumination system 14 includes an illumination source 34 and an illumination-optical assembly 36. The illumination source 34 emits a beam of light energy. The illumination-optical assembly 36 guides the beam of light energy from the illumination source 34 to the optical assembly 16. The beam illuminates selectively different portions of the reticle 26 and exposes the wafer 28. In FIG. 1 the illumination source 34 is illustrated as being supported above the reticle-stage assembly 18. Typically, however, the illumination source 34 is secured to one of the sides of the apparatus frame 12, and the energy beam from the illumination source 34 is directed to above the reticle-stage assembly 18 with the illumination-optical assembly 36.

The illumination source 34 can be a high-pressure mercury lamp (producing, for example, g-line or i-line ultraviolet light), a KrF excimer laser, an ArF excimer laser, or a F₂ excimer laser, or an x-ray source. Alternatively, the illumination source 34 can produce a charged-particle beam such as an electron beam. An electron beam can be produced by, for example, a thermionic-emission type lanthanum hexaboride (LaB₆) source or a tantalum (Ta) cathode. Furthermore, in the case in which an electron beam is used, either a mask can be used or a pattern can be directly formed on the substrate without using a mask or reticle.

The assembly 16 typically is an optical assembly that, for example, projects and/or focuses the light energy passing through the reticle 26 to the wafer 28. Depending upon the design of the exposure apparatus 10, the image formed by the assembly 16 on the wafer can be magnified or reduced relative to the corresponding pattern on the reticle. Hence, the assembly 16 is not limited to a reduction system. It can alternatively be a 1× or a magnification system.

Whenever far-UV light such as light from an excimer laser is used for exposure, glass materials such as quartz and fluorite that transmit far-UV light can be used in the assembly 16. Whenever exposure using light from an F₂ excimer laser, extreme UV, or X-ray source is used, the assembly 16 can be catadioptric or reflective (the reticle desirably is a reflective type). Whenever an electron beam is used, the assembly 16 includes electron optics such as electron lenses and deflectors. The optical path for an extreme UV beam or electron beam should be in a vacuum.

Examples of catadioptric (reflective-refractive) optical systems are discussed in U.S. Pat. Nos. 5,668,672 and 5,835,275. In these cases, the reflecting optical device can be a catadioptric optical system incorporating a beam-splitter and a concave mirror. U.S. Pat. No. 5,689,377 also discusses a catadioptric optical system incorporating a concave mirror, etc., but without a beam-splitter. As far as is permitted by law, the disclosures in these U.S. patents are incorporated herein by reference.

The reticle-stage assembly 18 holds and positions the reticle 26 relative to the assembly 16 and the wafer 28. Somewhat similarly, the wafer stage assembly 20 holds and positions the wafer 28 with respect to the projected image of the illuminated portions of the reticle 26. The stage assemblies 18, 20 are controlled in a manner as discussed above and are configured as described in more detail below.

In photolithography systems, when linear motors (see U.S. Pat. Nos. 5,623,853 and 5,528,118) are used in a reticle-stage assembly 18 and/or in a wafer-stage assembly 20, the linear motors can be either an air-levitation type employing air bearings or a magnetic-levitation type using Lorentz force or reactance force. Additionally, the stage can move along a guide, or it can be a guideless type of stage. As far as is permitted by law, the disclosures in these U.S. Patents are incorporated herein by reference.

Alternatively, the reticle stage and/or wafer stage can be driven by a planar motor. A planar motor drives the stage by an electromagnetic force generated by a magnet unit having two-dimensionally arranged magnets and an armature-coil unit having two-dimensionally arranged coils in facing positions. With this type of driving system, either the magnet unit or the armature-coil unit is connected to the stage and the other unit is mounted on the moving-plane side of the stage.

Movement of the stages as described above generates reaction forces that can affect performance of the exposure system. Reaction forces generated by motion of the wafer stage can be mechanically transferred to the floor (ground) by using a frame member as discussed in U.S. Pat. No. 5,528,100. Additionally, reaction forces generated by motion of the reticle stage can be mechanically transferred to the floor (ground) using a frame member as discussed in U.S. Pat. No. 5,874,820. As far as is permitted by law, the disclosures in these U.S. Patents are incorporated herein by reference.

Typically, multiple integrated circuits or other micro-devices are produced on a single wafer 28. The process may involve a substantial number of repetitive, identical, or substantially similar movements of portions of the reticle-stage assembly 18 and/or the wafer-stage assembly 20. Each such repetitive movement is also referred to herein as an iteration, iterative movement, or cycle, as defined in greater detail below.

The measurement system 22 monitors movement of the reticle 26 and the wafer 28 relative to the assembly 16 or some other reference. With this information, the control system 24 controls the reticle-stage assembly 18 to precisely position the reticle 26 and the wafer-stage assembly 20 to precisely position the wafer 28 relative to the assembly 16. For example, the measurement system 22 can utilize multiple laser interferometers, encoders, and/or other measuring devices.

One or more sensors 23 can monitor and/or receive information regarding one or more components of the exposure apparatus 10. For example, the exposure apparatus 10 can include one or more sensors 23 positioned on or near the assembly 16, the frame 12, or other suitable components. Information from the sensor(s) 23 can be provided to the control system 24 for processing. In the embodiment illustrated in FIG. 1, the exposure apparatus 10 can include two spaced-apart, separate sensors 23 that are secured to the apparatus frame 12 and two spaced-apart, separate sensors 23 that are secured to the assembly 16. Alternatively, the sensors 23 can be positioned elsewhere. The type of sensor 23 can be varied. For example, one or more of the sensors 23 can be an accelerometer, an interferometer, a gyroscope, and/or other type of sensor.

The control system 24 receives information from the measurement system 22 and other systems and controls the stage assemblies 18, 20 to precisely and synchronously position the reticle 26 and the wafer 28 relative to the assembly 16 or other reference. The control system 24 includes one or more processors, filters, and other circuits for performing its functions, as discussed above.

An exposure apparatus according to the embodiments described herein can be built by assembling various subsystems in such a manner that prescribed mechanical accuracy, electrical accuracy, and optical accuracy are maintained. To maintain the various accuracies, prior to and following assembly, every optical system is adjusted to achieve its specified optical accuracy. Similarly, every mechanical system and every electrical system are adjusted to achieve their respective specified mechanical and electrical accuracies. The process of assembling each subsystem into an exposure system includes mechanical interfaces, electrical-circuit wiring connections, and air-pressure plumbing connections between each subsystem, as required. Also, each subsystem is typically assembled prior to assembling an exposure apparatus from the various subsystems. After assembly of an exposure apparatus from its various subsystems, a total adjustment is performed to make sure that accuracy and precision are maintained in the exposure apparatus. It is desirable to manufacture an exposure apparatus in a clean room in which temperature and cleanliness are controlled.

### Fabrication of Microelectronic Devices

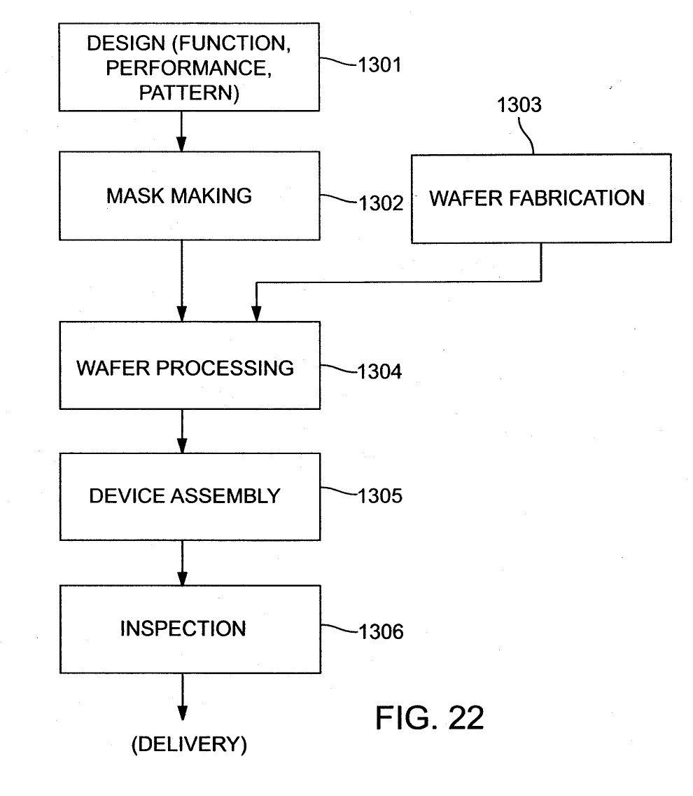

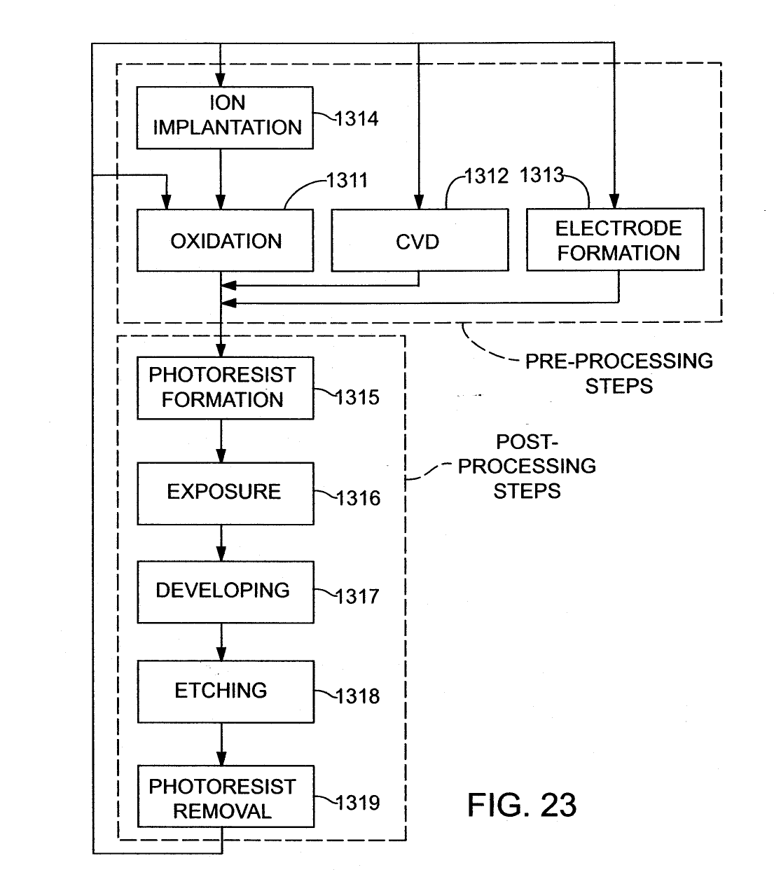

Microelectronic devices (such as, but not limited to, semiconductor devices) may be fabricated using the apparatus described above. An exemplary fabrication process is shown in FIG. 22. The process begins at step 1301 in which the function and performance characteristics of microelectronic device are designed or otherwise determined. Next, in step 1302, a reticle (mask) in which has a pattern is defined based upon the design of the microelectronic device. In a parallel step 1303, a wafer or other substrate is made from a silicon material, for example. In step 1304 the reticle pattern defined in step 1302 is exposed onto the wafer fabricated in step 1303 using an exposure apparatus that includes a coarse reticle-scanning stage and a fine reticle-scanning stage that moves with the coarse reticle-scanning stage. An exemplary process for exposing a reticle (mask) pattern onto a wafer is shown in FIG. 23, discussed below. In step 1305 the microelectronic device is assembled. The assembly of the device generally includes, but is not limited to, wafer-dicing processes, bonding processes, and packaging processes. Finally, the completed device is inspected in step 1306.

FIG. 23 is a process-flow diagram of the steps associated with wafer processing in the case of fabricating semiconductor devices in accordance with an embodiment. In step 1311, the surface of a wafer is oxidized. Then, in step 1312, which is a chemical vapor deposition (CVD) step, an insulative film is formed on the wafer surface. After the insulative film is formed, in step 1313 electrodes are formed on the wafer by vapor deposition. Then, in step 1314 ions are implanted in the wafer using substantially any suitable technique. Steps 1311-1314 are generally termed pre-processing steps for wafers during wafer processing. It will be understood that selections made in each step, e.g., the concentration of various chemicals to use in forming the insulative film in step 1312, may be made based upon processing requirements.

Upon completion of pre-processing steps, post-processing steps may be implemented. In step 1315 a layer of photoresist is applied to the wafer. Then, in step 1316, an exposure apparatus is used to transfer the circuit pattern defined on the reticle to the wafer. Transferring the circuit pattern of the reticle to the wafer generally includes executing a scanning motion of a reticle-scanning stage. In one embodiment, scanning the reticle-scanning stage includes accelerating a fine stage with a coarse stage, then accelerating the fine stage substantially independently from the coarse stage.

After transfer of the circuit pattern on the reticle to the wafer, the exposed wafer is developed in step 1317. After development of the wafer, parts thereof other than residual photoresist, e.g., the exposed material surface, may be removed by etching. Finally, in step 1319, unnecessary photoresist remaining after etching is removed. Multiple circuit patterns may be formed on the wafer by repeating the pre-processing and post-processing steps.

While the invention has been described above in connection with representative embodiments and examples, it will be understood that the invention is not limited to those embodiments and/or examples. On the contrary, it is intended to encompass all modifications, alternatives, and equivalents as may be included within the spirit and scope of the invention as defined by the appended claims.

What is claimed is:

1. A stage assembly, comprising:
a movable stage; and
a stage-control system coupled to the stage, the stage-control system comprising a first control loop and a second control loop;
the first control loop comprising a first controller programmed with a feedback-control transfer-function that determines a feedback-control output from an input including a following-error of the stage; and
the second control loop comprising an inverse closed loop, including an inverse plant model, and a second controller programmed with an adaptive transfer-function, the inverse plant model being connected to receive at least one input including the following-error, and the second controller being connected to receive at least one input including an output of the inverse closed loop and being programmed with an adaptive transfer-function that determines, from its at least one input, an adapted control output to the stage.

2. The assembly of claim 1, wherein:
the inverse plant model is connected to receive at least one input including the following-error; and
the inverse plant model produces an output that is summed with a delayed feedback-control output, the sum being input to the second controller.

3. The assembly of claim 1, wherein the adapted control output is summed with the feedback-control output for delivery to the stage.

4. The assembly of claim 1, wherein the feedback-control output as input to the second controller is delayed to synchronize the feedback-control output with the following-error as input to the inverse closed loop.

5. The assembly of claim 1, wherein the first and second control loops cooperatively reduce at least a periodic component of the following-error.

6. The assembly of claim 1, wherein the second control loop further comprises phase-ahead to accommodate at least some relative phase lag in the feedback-control output and following-error.

7. The assembly of claim 1, wherein the inverse plant model is applied to the following-error as input to the adaptive transfer-function of the second controller.

8. The assembly of claim 7, wherein the inverse plant model comprises an inverse nominal plant.

9. The assembly of claim 1, wherein the stage-control system further comprises a third control loop that is an open loop comprising a feed-forward controller.

10. The assembly of claim 9, wherein:
the feed-forward controller has at least one input selected from group consisting of snap, jerk, position trajectory, velocity trajectory, and position trajectory of the stage; and
the feed-forward controller has an output summed with the output of the second controller.

11. The assembly of claim 1, wherein the adaptive transfer-function of the second controller comprises an AFC transfer-function producing an AFC controlled output.

12. The assembly of claim 11, wherein the second controller comprises at least one shaping filter.

13. The assembly of claim 12, wherein the at least one shaping filter comprises at least one notch-filter programmed to attenuate a respective frequency component of the following-error.

14. The assembly of claim 13, wherein the notch-filter is an inverse notch-filter.

15. The assembly of claim 13, wherein the at least one shaping filter comprises multiple notch-filters arranged in series.

16. The assembly of claim 13, wherein the at least one shaping filter comprises multiple notch-filters arranged in parallel.

17. The assembly of claim 16, wherein respective outputs of the notch-filters are summed to produce the AFC controlled output.

18. The assembly of claim 11, wherein:
the inverse plant model receives an input including the following-error; and
the inverse plant model produces an output that is summed with a delayed feedback-control output, the sum being input to the AFC transfer-function of the second controller.

19. The assembly of claim 18, wherein the feedback-control output as input to the second controller is delayed.

20. The assembly of claim 11, wherein the AFC transfer-function produces an output that is summed with the feedback-control output for delivery to the stage.

21. The assembly of claim 11, wherein the stage-control system further comprises a third control loop that is an open loop comprising a feed-forward controller.

22. The assembly of claim 21, wherein:
the feed-forward controller has at least one input selected from the group consisting of snap, jerk, position trajectory, velocity trajectory, and acceleration trajectory of the stage; and
the feed-forward controller has an output summed with the output of second controller.

23. The assembly of claim 1, wherein the adaptive transfer-function comprises an ILC transfer-function producing an ILC controlled output.

24. The assembly of claim 23, wherein the second controller comprises an FIR low-pass filter, an ILC buffer, and a time-ahead.

25. The assembly of claim 23, wherein:
the inverse plant model receives an input including the following-error; and
the inverse plant model produces an output that is summed with a delayed feedback-control output, the sum being input to the ILC algorithm.

26. The assembly of claim 23, wherein the ILC transfer-function produces an output that is summed with the feedback-control output for delivery to the stage.

27. The assembly of claim 26, wherein the summed outputs are input directly to the stage.

28. The assembly of claim 26, wherein the stage includes at least one shaping filter receiving the summed outputs.

29. The assembly of claim 23, wherein the feedback-control output as input to the second controller is delayed.

30. The assembly of claim 23, wherein the stage-control system further comprises a third control loop that is an open loop comprising a feed-forward controller.

31. The assembly of claim 30, wherein:
the feed-forward controller has at least one input selected from the group consisting of snap, jerk, position trajectory, velocity trajectory, and acceleration trajectory of the stage; and
the feed-forward controller has an output summed with output of second controller.

32. A lithography system, comprising:
an optical system; and
a stage assembly, as recited in claim 1, situated relative to the optical system.

33. A stage assembly, comprising:
a movable stage;
a first controller programmed with a feedback-control algorithm;
a second controller programmed with an adaptive control algorithm;
a feedback loop coupling the first controller relative to the stage such that a feedback-force command determined by the first controller is routed to the stage, and stage-position data are fed back to upstream of an input of the first controller to provide the input with data including a following-error of the stage; and
an inverse closed loop coupled between the input of and an output of the first controller, the inverse closed loop including the second controller and an inverse plant model, the inverse plant model receiving the following-error and outputting to the second controller, and the second controller producing a command signal summed with the feedback-force command for delivery to the stage.

34. The assembly of claim 33, wherein the adaptive control algorithm is an AFC algorithm or an ILC algorithm.

35. The assembly of claim 34, further comprising a delay between the feedback-control force and the input to the second controller.

36. A method for controlling motion and positioning of a stage of a precision system, comprising:
selecting a trajectory for the stage;
producing stage-position data;
determining a stage following-error from the trajectory and from the stage-position data;
inputting the following-error to a feedback transfer-function to produce a feedback-control output;
processing the following-error in an inverse closed loop, including an inverse plant model, to produce an inverse closed-loop output;
inputting the inverse closed-loop output to an adaptive transfer-function to produce an adapted control output; and
positioning the stage according to the feedback-control output cooperating with the adapted control output.

37. The method of claim 36, wherein positioning the stage according to the feedback-control output cooperating with the adapted control output comprises:
summing the feedback-control output and adapted control output, and
delivering the summed outputs to the stage.

38. The method of claim 37, further comprising:
producing a feed-forward output; and
summing the feed-forward output with the summed outputs, wherein positioning the stage includes positioning the stage according to the summed feed-forward output, feedback-control output, and adapted control output.

39. The method of claim 38, wherein the feed-forward output is produced by a feed-forward algorithm receiving at least one input selected from the group consisting of snap, jerk, position trajectory, velocity trajectory, and acceleration trajectory.

40. The method of claim 36, further comprising delaying the feedback-control output input to the adaptive transfer-function.

41. The method of claim 40, wherein delaying the feedback-control output includes delaying by a discrete time.

42. The method of claim 40, wherein delaying the feedback-control output includes delaying by a continuous time.

43. The method of claim 36, wherein the adaptive transfer-function in the inverse closed loop comprises an AFC algorithm from which the adapted control output is an AFC controlled output.

44. The method of claim 43, wherein processing according to the AFC algorithm includes processing according to at least one shaping algorithm.

45. The method of claim 43, wherein processing according to the AFC algorithm includes processing according to at least one notch algorithm.

46. The method of claim 36, wherein the adaptive transfer-function comprises an ILC algorithm.

47. The method of claim 46, wherein positioning the stage according to the feedback-control output cooperating with the adapted control output includes:
summing the feedback-control output and the adapted control output; and
passing the summed control outputs through a shaping filter before delivery to the stage.
